(19) United States
(12) Patent Application Publication
(10) Pub. No.: US 2023/0030319 A1
(43) Pub. Date: Feb. 2, 2023

(54) GAS TURBINE ENGINE STARTER SYSTEMS AND ASSOCIATED METHODS

(71) Applicant: The Boeing Company, Chicago, IL (US)

(72) Inventor: John Carl Szillat, Bellevue, WA (US)

(21) Appl. No.: 17/389,144

(22) Filed: Jul. 29, 2021

(51) Int. Cl. F02C 7/275; F02C 7/32

(52) U.S. Cl. CPC F02C 7/275; F02C 7/32; F05D 2260/85; F05D 2220/323; F05D 2220/50; F05D 2270/304; F05D 2270/114

(57) ABSTRACT

Gas turbine engine starter systems and associated methods. A gas turbine engine starter system includes an engine starter with a starter torque output configured to convey a starter torque to a gas turbine engine. An engine startup process includes a spool-up time interval in which the engine rotational speed increases to a speed within an engine starting speed envelope. During at least a portion of the spool-up time interval, the starter torque is less than a speed-dependent maximum torque value of the starter torque that the engine starter is configured to produce. A method of operating a gas turbine engine starter system includes operating an engine starter to accelerate the gas turbine engine such that the starter torque is less than a speed-dependent maximum torque value of the starter torque that the engine starter is configured to produce during at least a portion of a spool-up time interval.

### FIELD

The present disclosure relates to gas turbine engine starter systems and associated methods.

### BACKGROUND

During standard, steady-state operating conditions, a gas turbine engine operates to produce an engine torque via a continuous and self-sustaining combustion process. The combustion process generates combustion gases that drive a turbine, which in turn drives a compressor via an engine shaft to provide an airflow that fuels to the combustion process. However, in order to initiate self-sustaining operation of a gas turbine engine, an external power source is necessary to initiate rotation of the turbine, the compressor, and/or the engine shaft until the combustion process becomes self-sustaining. In many examples, this external power source is provided in the form of an engine starter that includes an electric motor that accelerates the gas turbine engine components from rest. However, various conventional engine starters are not configured for regulation of the electric motor other than by commanding the electric motor to an “on” or an “off” state. As a result, the resulting acceleration of the components of the gas turbine engine may be uncontrolled, and/or may proceed at a rate that is not optimally conducive to initiating self-sustaining operation of the gas turbine engine. Thus, there exists a need for improved gas turbine engine starter systems and associated methods.

### SUMMARY

Gas turbine engine starter systems and associated methods are disclosed herein. A gas turbine engine starter system for initiating operation of a gas turbine engine during an engine startup process includes an engine starter. The engine starter is configured to generate a starter torque during the engine startup process to initiate operation of the gas turbine engine to produce an engine torque. The engine starter includes a starter torque output that is configured to rotate at a starter rotational speed and to convey the starter torque to the gas turbine engine during the engine startup process to initiate operation of the gas turbine engine. The gas turbine engine is characterized by an engine starting speed envelope that encompasses a range of engine starting rotational speeds corresponding to initiation of a combustion process within the gas turbine engine during the engine startup process. The engine startup process includes a spool-up time interval in which the engine rotational speed increases from a non-operative engine rotational speed to a speed within the engine starting speed envelope. The gas turbine engine starter system is configured such that, during operative use of the gas turbine engine starter system and during at least a portion of the spool-up time interval, the starter torque is less than a speed-dependent maximum torque value of the starter torque that the engine starter is configured to produce.

A method of operating a gas turbine engine starter system to initiate operation of a gas turbine engine during an engine startup process includes utilizing an engine starter of the gas turbine engine starter system. Specifically, the engine starter is configured to generate a starter torque during the engine startup process to initiate operation of the gas turbine engine. The gas turbine engine starter system additionally includes an engine controller programmed to generate and transmit a starter control signal to the engine starter. The method of operating the gas turbine engine starter system includes regulating the operation of the engine starter with the engine controller. Specifically, the regulating the operation of the engine starter includes accelerating the gas turbine engine to bring an engine rotational speed of the gas turbine engine to within an engine starting speed envelope that encompasses a range of engine starting rotational speeds corresponding to initiation of a combustion process within the gas turbine engine during the engine startup process. The accelerating the gas turbine engine includes operating the engine starter such that the starter torque is less than a speed-dependent maximum torque value of the starter torque that the engine starter is configured to produce during at least a portion of a spool-up time interval of the engine startup process. Specifically, during the spool-up time interval, the engine rotational speed increases from a non-operative engine rotational speed to a speed within the engine starting speed envelope.

### BRIEF DESCRIPTION OF THE DRAWINGS

FIG. 1 illustrates an example of a vehicle in the form of an aircraft including examples of gas turbine engine starter systems according to the present disclosure.

FIG. 2 is a schematic illustration of examples of gas turbine engine starter systems according to the present disclosure.

FIG. 3 is a graph illustrating examples of time-varying engine rotational speeds of examples of gas turbine engines during examples of engine startup process according to the present disclosure.

FIG. 4 is a graph illustrating examples of starter torque curves characterizing examples of engine starters during examples of engine startup process according to the present disclosure.

FIG. 5 is a flowchart representing examples of methods, according to the present disclosure, of operating a gas turbine engine starter system.

### DESCRIPTION

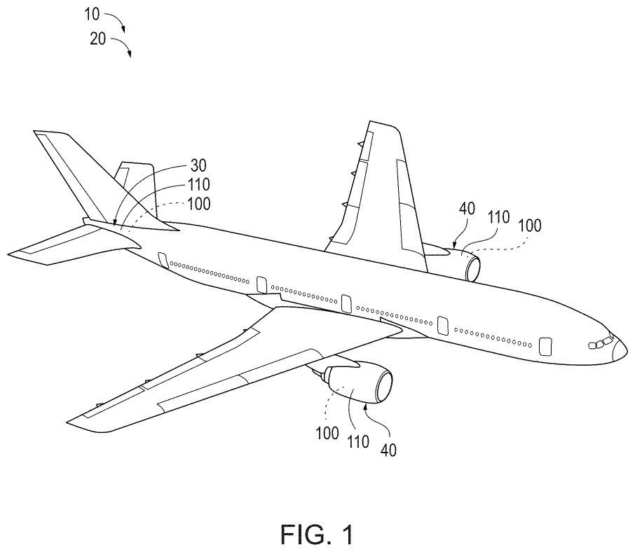

FIGS. 1-5 provide illustrative, non-exclusive examples of gas turbine engine starter systems 100, of vehicles 10 including gas turbine engine starter systems 100, and/or of methods 400 of operating gas turbine engine starter systems 100, according to the present disclosure. Elements that serve a similar, or at least substantially similar, purpose are labeled with like numbers in each of FIGS. 1-5, and these elements may not be discussed in detail herein with reference to each of FIGS. 1-5. Similarly, all elements may not be labeled in each of FIGS. 1-5, but reference numerals associated therewith may be utilized herein for consistency. Elements, components, and/or features that are discussed herein with reference to one or more of FIGS. 1-5 may be included in and/or utilized with any of FIGS. 1-5 without departing from the scope of the present disclosure.

Generally, in the Figures, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a given example without departing from the scope of the present disclosure. Additionally, in some Figures, one or more components and/or portions thereof that are obscured from view also may be illustrated in dashed lines.

FIG. 1 illustrates an example of a vehicle 10 in the form of an aircraft 20 that may include, utilize, and/or incorporate gas turbine engine starter systems 100 according to the present disclosure. In particular, FIG. 1 illustrates an example in which aircraft 20 includes a plurality of gas turbine engines 110, each of which may be utilized in conjunction with gas turbine engine starter system 100. More specifically, in some examples, and as illustrated in FIG. 1, vehicle 10 and/or aircraft 20 includes an auxiliary power unit (APU) 30 that includes a corresponding gas turbine engine 110 and that includes and/or utilizes gas turbine engine starter system 100 in conjunction with the corresponding gas turbine engine 110. Additionally or alternatively, in some examples, and as illustrated in FIG. 1, vehicle 10 and/or aircraft 20 includes one or more turbofan engines 40, each of which includes a corresponding gas turbine engine 110, and each of which includes and/or utilizes gas turbine engine starter system 100 in conjunction with the corresponding gas turbine engine 110. However, such examples are not limiting, and it additionally is within the scope of the present disclosure that gas turbine engine starter system 100 may be utilized in conjunction with any suitable gas turbine engine 110 of vehicle 10 and/or of aircraft 20. Additionally, while the present disclosure generally relates to examples in which gas turbine engine starter system 100 is utilized in conjunction with vehicle 10 in the form of aircraft 20, this is not required of all examples of gas turbine engine starter system 100, and it additionally is within the scope of the present disclosure that vehicle 10 may be any of a variety of vehicles that utilize one or more gas turbine engines 110. Moreover, it further is within the scope of the present disclosure that gas turbine engine starter system 100 may be utilized in conjunction with an example of gas turbine engine 110 that is not utilized in conjunction with a vehicle 10.

As described in more detail herein, the present disclosure relates generally to a gas turbine engine starter system 100 with an engine starter 200 for initiating operation of a gas turbine engine 110 during an engine startup process. In particular, and as described in more detail herein, operation of gas turbine engine 110 may be described in terms of an engine rotational speed thereof, and gas turbine engine starter system 100 is configured to utilize engine starter 200 to increase the engine rotational speed during the engine startup process of gas turbine engine 110.

As used herein, the term “engine startup process” refers to a series of events, and/or to one or more time intervals in which the events take place, during which gas turbine engine 110 transitions from an inactive and/or initial state, in which the engine rotational speed is a non-operative engine rotational speed, to an operational state, in which gas turbine engine 110 operates independent of engine starter 200 and in which the engine rotational speed is greater than the non-operative engine rotational speed. Accordingly, the engine startup process encompasses a period of time in which gas turbine engine starter system 100 is in operative use to initiate operation of gas turbine engine 110, as described herein. In some examples, the non-operative engine rotational speed represents an engine rotational speed of zero. However, this is not required, and it additionally is within the scope of the present disclosure that the non-operative engine speed characterizing the beginning of the engine startup process may be nonzero, such as an engine rotational speed that is negligible, that is close to zero, and/or that otherwise is insufficient for continuous operation of gas turbine engine 110. In some examples, and as described herein, the engine startup process encompasses a period of time that extends beyond the period of time in which gas turbine engine starter system 100 is in operative use to initiate operation of gas turbine engine 110.

As used herein, the term “operative use,” as used to describe a state and/or condition of gas turbine engine starter system 100, is intended to refer to any state and/or condition in which gas turbine engine starter system 100 and/or engine starter 200 is actively utilized to increase the engine rotational speed as described herein. Accordingly, descriptions herein of gas turbine engine starter system 100 and/or of engine starter 200 as being operatively utilized, and/or as being in operative use, are to be understood as referring to circumstances, processes, and/or instances that take place within the engine startup process.

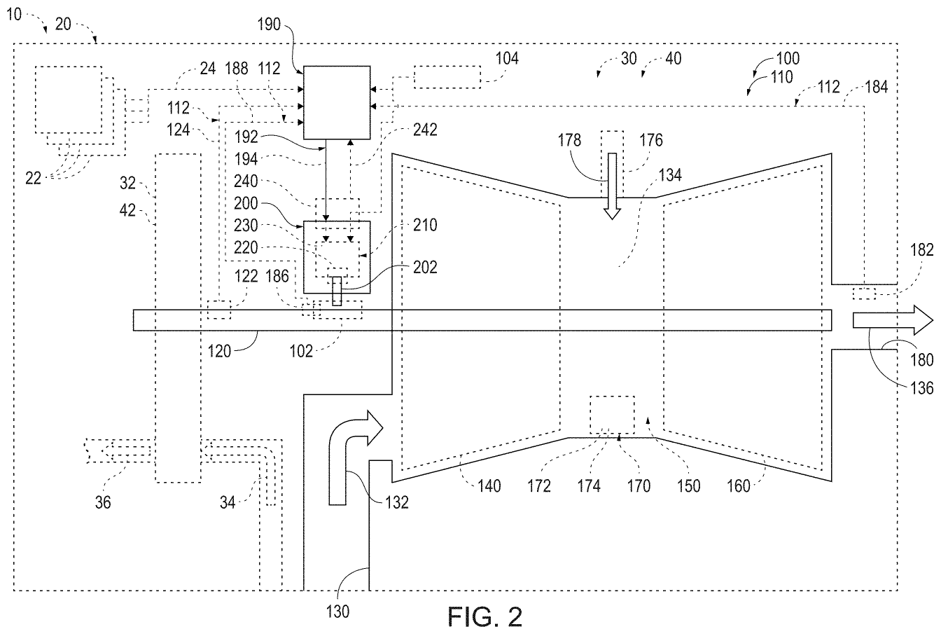

Gas turbine engine starter system 100 is configured to be utilized in conjunction with examples of gas turbine engine 110 in which a self-sustaining combustion process operates to generate an engine torque. In some examples, gas turbine engine starter system 100 may be described as including gas turbine engine 110. In other examples, gas turbine engine starter system 100 may be described as being a system that is distinct from gas turbine engine 110 and that is utilized in conjunction with gas turbine engine 110. Examples of gas turbine engine starter systems 100 and of gas turbine engines 110 are schematically illustrated in FIG. 2.

As schematically illustrated in FIG. 2, gas turbine engine 110 includes an engine shaft 120 that is configured to rotate at the engine rotational speed, such as to convey an engine torque to one or more other components. In particular, in various examples, gas turbine engine 110 is operable to produce an engine torque and to convey the engine torque via engine shaft 120. Gas turbine engine 110 may include any of a variety of components, such as may be typical and/or representative of conventional gas turbine engines. In particular, in some examples, and as schematically illustrated in FIG. 2, gas turbine engine 110 includes a powerhead compressor 140 configured to compress an engine airflow 132 and a combustion chamber 150 configured to combust an air-fuel mixture 134 that includes a mixture of engine airflow 132 and a fuel flow 178 to produce combustion gases 136. In such examples, gas turbine engine 110 further includes a powerhead turbine 160 configured to extract energy from combustion gases 136 to produce the engine torque. More specifically, in some examples, gas turbine engine 110 is configured such that the expansion of combustion gases 136 drives powerhead turbine 160, which in turn drives rotation of engine shaft 120. In some such examples, the combustion-driven rotation of engine shaft 120 operates to drive the rotation of powerhead compressor 140, thereby introducing engine airflow 132 to combustion chamber 150 to enable self-sustaining operation of gas turbine engine 110. In some examples, and as schematically illustrated in FIG. 2, gas turbine engine 110 further includes an air intake 130 for introducing engine airflow 132 into powerhead compressor 140 and/or an exhaust outlet 180 for exhausting combustion gases 136 from gas turbine engine 110.

Gas turbine engine 110 may be a component of, and/or may be operatively utilized in conjunction with, any of a variety of systems, such as may be associated with vehicle 10. For example, and as schematically illustrated in FIG. 2, in some examples in which gas turbine engine 110 is a component of APU 30, APU 30 includes a load compressor 32 that is configured to compress a load compressor airflow 34 to generate a bleed air flow 36, such as may be utilized by one or more systems of vehicle 10. In some such examples, gas turbine engine 110 is configured such that the engine torque provided by engine shaft 120 operates to drive load compressor 32 to generate bleed air flow 36. Stated differently, in such examples, engine shaft 120 operatively couples powerhead turbine 160 to load compressor 32 to convey the engine torque from powerhead turbine 160 to load compressor 32.

In some other examples, and as schematically illustrated in FIG. 2, gas turbine engine 110 is a component of turbofan engine 40, which includes a fan 42 that is configured to accelerate an airflow to produce a thrust, such as to propel vehicle 10. In some such examples, gas turbine engine 110 is configured such that the engine torque provided by engine shaft 120 operates to drive rotation of fan 42. Stated differently, in such examples, engine shaft 120 operatively couples powerhead turbine 160 to fan 42 to convey the engine torque from powerhead turbine 160 to fan 42.

In many cases, in order to transition gas turbine engine 110 from an initially inactive state to a state of self-sustaining operation, it is necessary to initiate rotation of engine shaft 120 and/or of powerhead compressor 140, such as with an externally applied torque. Accordingly, and as schematically illustrated in FIG. 2, gas turbine engine starter system 100 includes an engine starter 200 that is configured to generate a starter torque during the engine startup process to initiate operation of gas turbine engine 110 to produce the engine torque. Specifically, engine starter 200 includes a starter torque output 202 that is configured to rotate at a starter rotational speed and to convey the starter torque to gas turbine engine 110 during the engine startup process, such as to initiate and/or accelerate rotation of engine shaft 120 and/or of powerhead compressor 140. Examples of starter torque output 202 include a gear, a pinion gear, and/or a splined mechanical interface. In some examples, and as schematically illustrated in FIG. 2 and as discussed in more detail herein, engine starter 200 includes a starter motor 210 that is configured to produce the starter torque.

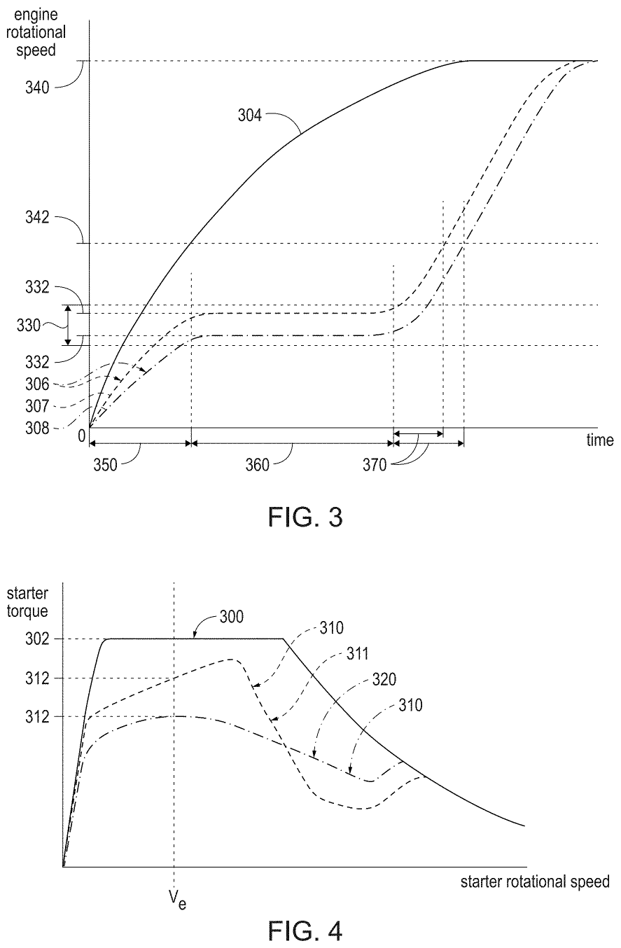

In many cases, in order to initiate self-sustaining operation of gas turbine engine 110, it is necessary to utilize engine starter 200 to accelerate the engine rotational speed to a speed at which powerhead compressor 140 drives engine airflow 132 to combustion chamber 150 at a sufficient flow rate to stably support the combustion process within combustion chamber 150. Such an engine rotational speed may be a characteristic of gas turbine engine 110, and/or may be at least partially based upon various environmental factors affecting gas turbine engine 110. To illustrate this, FIG. 3 provides a graph of examples of the engine rotational speed as a function of time elapsed after initiating a start-up procedure of gas turbine engine 110 during the engine startup process. With reference to FIG. 3, gas turbine engine 110 is characterized by an engine starting speed envelope 330 that encompasses a range of engine starting rotational speeds 332 corresponding to initiation of a combustion process within combustion chamber 150. In particular, in some examples, engine starting speed envelope 330 encompasses a range of engine starting rotational speeds 332 at which powerhead compressor 140 drives engine airflow 132 to combustion chamber 150 at a flow rate that is conducive to initiation of a stable and/or continuous combustion of air-fuel mixture 134 within combustion chamber 150. Gas turbine engines 110 that are utilized in conjunction with gas turbine engine starter systems 100 according to the present disclosure are characterized by engine starting speed envelope 330 such that each engine starting rotational speed 332 corresponding to any of a variety of operational conditions of gas turbine engine 110 is within the range defined by engine starting speed envelope 330.

For a particular instance and/or circumstance in which gas turbine engine 110 transitions from the inactive state to a state of stable and/or self-sustaining operation, engine starting rotational speed 332 corresponds to an engine rotational speed that is conducive to initiation of stable and/or self-sustaining combustion of air-fuel mixture 134 within combustion chamber 150, which may depend upon any of a variety of variable factors. In particular, in some examples, engine starting rotational speed 332 is at least partially based upon an operational condition of gas turbine engine 110, such as a temperature associated with gas turbine engine 110, an operational age of gas turbine engine 110, a size of gas turbine engine 110, etc. In some examples, and as discussed, engine starting rotational speed 332 corresponds to an optimized engine rotational speed, such as a speed at which powerhead compressor 140 feeds engine airflow 132 into combustion chamber 150 at a rate that facilitates and/or optimizes a stable and/or complete combustion of air-fuel mixture 134. In this manner, in various examples, it is not necessary that gas turbine engine 110 remains precisely at a particular engine starting rotational speed 332 in order to initiate combustion of air-fuel mixture 134 and/or operation of gas turbine engine 110, so long as the engine rotational speed is within engine starting speed envelope 330.

Turning to FIG. 4, FIG. 4 provides a graph of examples of plots of the starter torque produced by engine starter 200 as a function of the starter rotational speed during a particular instance and/or execution of the engine startup process. In particular, in various examples, and as shown in FIG. 4, engine starter 200 is characterized by a maximum starter torque curve 300 that represents a speed-dependent maximum torque value 302 of the starter torque that engine starter 200 is configured to produce as a function of the starter rotational speed. Stated differently, in various examples, the maximum value of the starter torque that engine starter 200 is configured to produce varies with the starter rotational speed of engine starter 200. Accordingly, and with reference to FIG. 4, speed-dependent maximum torque value 302 generally is a time-dependent quantity, and maximum starter torque curve 300 represents the set of speed-dependent maximum torque values 302 across a range of starter rotational speeds, such as a range of starter rotational speeds that are produced during the engine startup process.

As used herein, the term “torque curve,” as used to characterize the operation of engine starter 200, is intended to refer to a graph, a plot, and/or a series of values of the starter torque that are produced by engine starter 200 as a function of the starter rotational speed during the engine startup process. In this manner, and as described in more detail herein, maximum starter torque curve 300 illustrated in FIG. 4 represents one of a plurality of torque curves that may be representative of the operation of engine starter 200 during the engine startup process. Additionally, in this manner, descriptions herein of engine starter 200 “following” a particular torque curve are intended to refer to processes (e.g., instances of the engine startup process) in which the operation of engine starter 200 is characterized by the particular torque curve. As used herein, maximum starter torque curve 300 also may be referred to as a motor power rating 300 of engine starter 200 and/or of starter motor 210.

In some examples, it may be undesirable and/or relatively inefficient to operate engine starter 200 to produce speed-dependent maximum torque value 302 at each value of the starter rotational speed during the engine startup process (e.g., in a manner that follows maximum starter torque curve 300). In particular, in some examples, such operation may accelerate the engine rotational speed overly rapidly for efficient initiation of operation of gas turbine engine 110, and/or may result in premature wear of one or more components of gas turbine engine starter system 100. As a more specific example, FIG. 3 illustrates in solid line a maximum engine acceleration profile 304, which represents an example of the time-dependent engine rotational speed when engine starter 200 is operated according to maximum starter torque curve 300 (as illustrated in FIG. 4) during the engine startup process.

As additionally shown in FIG. 3, the engine startup process includes a spool-up time interval 350 in which the engine rotational speed increases from the non-operative engine rotational speed (e.g., zero) to a speed within engine starting speed envelope 330. In particular, in this example, and as illustrated in FIG. 3, operating engine starter 200 according to maximum starter torque curve 300 causes the engine rotational speed to increase very rapidly within spool-up time interval 350. As a result, in this example, the engine rotational speed represented by maximum engine acceleration profile 304 occupies engine starting speed envelope 330 for a very short period of time, which in turn may limit an effectiveness and/or an efficiency with which the combustion process within combustion chamber 150 may initiate and/or become self-sustaining. Accordingly, gas turbine engine starter systems 100 according to the present disclosure are configured to operate engine starter 200 to produce the starter torque with a value that is less than speed-dependent maximum torque value 302 during at least a portion of the engine startup process. More specifically, gas turbine engine starter system 100 is configured such that, during operative use of gas turbine engine starter system 100 and during at least a portion of spool-up time interval 350, the starter torque that is produced by engine starter 200 is less than speed-dependent maximum torque value 302. Stated differently, gas turbine engine starter system 100 is configured such that the value of the starter torque that is produced at each starter rotational speed within at least a subset of the range of starter rotational speeds that are produced during spool-up time interval 350 is less than speed-dependent maximum torque value 302 at each such starter rotational speed. In this manner, gas turbine engine starter system 100 is configured such that the torque curve followed by engine starter 200 during the engine startup process at least partially diverges from maximum starter torque curve 300 within at least a portion of spool-up time interval 350. Accordingly, and as described in more detail herein, gas turbine engine starter systems 100 according to the present disclosure may facilitate efficient initiation of operation of gas turbine engine 110 and/or may facilitate performing the engine startup process with reduced wear of engine starter 200, relative to prior art examples of engine starter systems. Moreover, gas turbine engine starter systems 100 according to the present disclosure may facilitate initiation of operation of gas turbine engine 110 with a decreased peak power draw from a power supply that powers engine starter 200 (such as starter power supply 104 disclosed herein) relative to prior art examples of engine starter systems. In particular, because gas turbine engine starter systems 100 according to the present disclosure operate engine starter 200 to produce less than a maximum torque output within at least a portion of spool-up time interval 350, a peak power requirement of engine starter 200 is regulated correspondingly, which in some examples prolongs a reliability and/or an operational lifespan of engine starter 200 and/or its power supply.

As discussed, gas turbine engine starter system 100 is configured such that the torque curve followed by engine starter 200 during the engine startup process at least partially diverges from maximum starter torque curve 300, at least within spool-up time interval 350. In particular, in some examples, and as illustrated in FIG. 4, engine starter 200 is characterized by a regulated starter torque curve 310 that represents a speed-dependent regulated torque value 312 of the starter torque that is produced by engine starter 200 during operative use of gas turbine engine starter system 100. Stated differently, engine starter 200 may be described as following regulated starter torque curve 310 during the engine startup process, such that, at each particular value of the starter rotational speed produced during the engine startup process, the value of the starter torque is equal to speed-dependent regulated torque value 312 as defined at the particular value of the starter rotational speed. Accordingly, in such examples, gas turbine engine starter system 100 is configured such that speed-dependent regulated torque value 312 of the starter torque is less than speed-dependent maximum torque value 302 of the starter torque at each starter rotational speed of a set, sequence, and/or interval of starter rotational speeds that are produced during at least a portion of spool-up time interval 350.

In many examples, and as described in more detail herein, gas turbine engine starter system 100 is configured to generate the starter torque such that the engine rotational speed of gas turbine engine 110 varies according to a predetermined and/or targeted acceleration profile during at least a portion of the engine startup process. In particular, in some examples, and with reference to FIG. 3, gas turbine engine starter system 100 is configured such that engine starter 200 generates the starter torque in such a manner that the engine rotational speed follows a selected predetermined engine target acceleration profile 306 during at least a portion of spool-up time interval 350. That is, in such examples, selected predetermined engine target acceleration profile 306 represents a predetermined manner in which the engine rotational speed is intended and/or prescribed to progress over time during at least a portion of the engine startup process. Accordingly, in such examples, the operation of engine starter 200 is configured, modulated, regulated, etc. such that the actual time-dependent engine rotational speed remains equal to, at least substantially equal to, and/or or nominally fully equal to, the engine rotational speed prescribed by selected predetermined engine target acceleration profile 306 during at least a portion of the engine startup process. In this manner, in such examples, an instance of regulated starter torque curve 310 that characterizes the operation of engine starter 200 during an instance of the engine startup process is at least partially based upon a corresponding selected predetermined engine target acceleration profile 306 that is utilized during the instance of the engine startup process. As used herein, selected predetermined engine target acceleration profile 306 also may be referred to as a selected engine target acceleration profile 306, as a predetermined engine target acceleration profile 306, and/or as an engine target acceleration profile 306.

The precise form, instance, and/or selection of engine target acceleration profile 306 that is utilized in conjunction with a particular execution of the engine startup process may be based on any of a variety of factors. FIG. 3 illustrates two examples of engine target acceleration profile 306, in the form of a first engine target acceleration profile 307 (illustrated in dashed lines) and a second engine target acceleration profile 308 (illustrated in dash-dot lines). As illustrated in FIG. 3, first engine target acceleration profile 307 represents a process (e.g., an example of the engine startup process) in which the engine rotational speed is accelerated more rapidly in spool-up time interval 350 relative to second engine target acceleration profile 308. In particular, first engine target acceleration profile 307 may correspond to (e.g., may be selected in) an instance in which gas turbine engine 110 has a relatively high temperature, whereas second engine target acceleration profile 308 may correspond to (e.g., may be selected in) an instance in which gas turbine engine 110 has a relatively low temperature. In particular, in some examples, it is desirable and/or necessary to accelerate the engine rotational speed more gradually within spool-up time interval 350 when gas turbine engine 110 is “cold,” such as when gas turbine engine 110 operates in cold environmental conditions and/or when gas turbine engine 110 previously has been inactive for an extended period of time.

As discussed in more detail herein, gas turbine engine starter system 100 generally is configured to operate engine starter 200 in such a manner that the actual engine rotational speed of gas turbine engine 110 during the engine startup process matches the series of engine startup speeds represented by engine target acceleration profile 306. However, it is to be understood that it is within the scope of the present disclosure that the actual engine rotational speed of gas turbine engine 110 is not exactly equal to the engine rotational speed prescribed by engine target acceleration profile 306 during the engine startup process. In particular, in some examples of the engine startup process, the engine rotational speed of gas turbine engine 110 deviates from the engine rotational speed represented by engine target acceleration profile 306 within at least a portion of the engine startup process by an average deviation that is at most 10%, at most 5%, and/or at most 1%.

As discussed, the precise form, instance, and/or configuration of regulated starter torque curve 310 that characterizes a particular instance and/or execution of the engine startup process is at least partially based upon the precise form, instance, and/or selection of engine target acceleration profile 306 that is utilized in conjunction with the particular instance and/or execution of the engine startup process. In this manner, regulated starter torque curve 310 may have any of a variety of forms, each of which depends at least in part on the corresponding engine target acceleration profile 306. In particular, the example of regulated starter torque curve 310 illustrated in FIG. 4 represents one of a plurality of examples of regulated starter torque curve 310 that may be followed by engine starter 200 during the engine startup process. Stated differently, in some examples, multiple iterations of the engine startup process that correspond to a particular precise form of engine target acceleration profile 306 may yield different regulated starter torque curves 310, depending upon a variety of environmental and/or mechanical factors.

For example, and with reference to FIG. 4, regulated starter torque curve 310 may be described as a first regulated starter torque curve 311 (illustrated in dashed lines), and engine starter 200 additionally or alternatively may be characterized by a second regulated starter torque curve 320 (illustrated in dash-dot lines), which is another example of regulated starter torque curve 310. That is, in some examples, the operation of engine starter 200 during operative use of gas turbine engine starter system 100 and/or during the engine startup process is characterized by first regulated starter torque curve 311, by second regulated starter torque curve 320, or by any other suitable regulated starter torque curve 310 according to the present disclosure.

Stated differently, first regulated starter torque curve 311 and second regulated starter torque curve 320 represent two of a broader plurality of examples of regulated starter torque curves 310 according to the present disclosure. More specifically, in the examples of FIGS. 3-4, first regulated starter torque curve 311 of FIG. 4 may be described as representing an example of regulated starter torque curve 310 that is produced when gas turbine engine starter system 100 operates engine starter 200 to accelerate the engine rotational speed according to first engine target acceleration profile 307 of FIG. 3. Similarly, second regulated starter torque curve 320 of FIG. 4 may be described as representing an example of regulated starter torque curve 310 that is produced when gas turbine engine starter system 100 operates engine starter 200 to accelerate the engine rotational speed according to second engine target acceleration profile 308 of FIG. 3. However, these examples are provided by way of illustration only, and it is to be understood that a relative magnitude of the starter torque that is generated by engine starter 200 is not necessarily proportional to a relative magnitude of the resulting engine rotational speed. In particular, while FIGS. 3-4 illustrate examples in which a relatively low value of the starter torque (e.g., as exhibited by second regulated starter torque curve 320 relative to first regulated starter torque curve 311 at the starter rotational speed vₑ in FIG. 4) correlates to a relatively low value of the engine rotational speed and/or acceleration thereof (e.g., as exhibited by second engine target acceleration profile 308 relative to first engine target acceleration profile 307 in FIG. 3), this is not required of all examples of gas turbine engine starter system 100. For example, it also is within the scope of the present disclosure that first regulated starter torque curve 311 of FIG. 4 may correspond to second engine target acceleration profile 308 of FIG. 3 and/or that second regulated starter torque curve 320 of FIG. 4 may correspond to first engine target acceleration profile 307 of FIG. 3, such as depending upon various operational and/or environmental conditions. It also is within the scope of the present disclosure that different values of the starter torque generated by engine starter 200 may yield the same or similar values of the magnitude and/or acceleration of the engine rotational speed, and/or that a particular value of the starter torque generated by engine starter 200 may yield different values of the magnitude and/or acceleration of the engine rotational speed. In particular, such variability may result from various operational and/or environmental conditions during separate instances of the engine startup process, such as a temperature of gas turbine engine 110 and/or of an ambient environment.

FIG. 4 additionally illustrates a manner in which each example regulated starter torque curve 310 departs from maximum starter torque curve 300. Specifically, FIG. 4 illustrates examples in which, at a specific starter rotational speed vₑ, the respective speed-dependent regulated torque value 312 of each example regulated starter torque curve 310 is lower than speed-dependent maximum torque value 302 at the starter rotational speed vₑ. In this manner, vₑ may be described as representing a starter rotational speed of the sequence and/or interval of starter rotational speeds that are produced when the engine startup process is in spool-up time interval 350.

The examples of first regulated starter torque curve 311 and second regulated starter torque curve 320 presented in FIG. 4 are provided by way of illustration only, and it is to be understood that each example of engine target acceleration profile 306 does not necessarily correspond to a respective example of regulated starter torque curve 310 in a one-to-one manner. In particular, and as discussed, the actual form of regulated starter torque curve 310 corresponding to a given (e.g., a particular, a predetermined, and/or a selected) engine target acceleration profile 306 may depend not only upon the given engine target acceleration profile 306, but instead further may depend on any of a variety of environmental and/or mechanical factors affecting gas turbine engine starter system 100 and/or engine starter 200.

In some examples, and as illustrated in FIG. 3, the engine startup process further includes a dwell time interval 360 that initiates immediately subsequent to the end of spool-up time interval 350. In particular, in such examples, gas turbine engine starter system 100 is configured such that the engine rotational speed remains within engine starting speed envelope 330 during dwell time interval 360. In some examples, maintaining the engine rotational speed within engine starting speed envelope 330 during dwell time interval 360 facilitates initiation of operation of gas turbine engine 110, such as by maintaining conditions (e.g., a flow rate of engine airflow 132) that promote the initiation of stable and/or self-sustaining combustion within combustion chamber 150.

Such functionality is illustrated in FIG. 3, in which each of first engine target acceleration profile 307 and second engine target acceleration profile 308 maintains the engine rotational speed within engine starting speed envelope 330 during dwell time interval 360. As discussed, however, first engine target acceleration profile 307 and second engine target acceleration profile 308 are only two examples of engine target acceleration profile 306, and it is (non-exclusively) within the scope of the present disclosure that engine target acceleration profile 306 has any suitable form such that the engine rotational speed remains within engine starting speed envelope 330 during dwell time interval 360.

In some examples, and as discussed in more detail herein, dwell time interval 360 is not a predetermined and/or prescribed duration of time, but rather is at least partially based upon one or more measured and/or calculated factors that at least partially determine the beginning and/or the end of dwell time interval 360. In this manner, dwell time interval 360 may encompass any suitable interval of time, examples of which include at least 0.5 seconds (s), at least 1 s, at least 3 s, at least 5 s, and at most 10 s. In particular, in some examples, and as described in more detail herein, the end of dwell time interval 360 (i.e., the moment within the engine startup process at which dwell time interval 360 terminates) is at least partially based upon a measured property associated with the operation of gas turbine engine 110, and thus is not necessarily predetermined. Accordingly, in some such examples, the trajectory of the time evolution of the engine rotational speed is not defined by engine target acceleration profile 306 at times subsequent to the end of dwell time interval 360. In particular, although FIG. 3 illustrates each of first engine target acceleration profile 307 and second engine target acceleration profile 308 as extending to times beyond the end of dwell time interval 360, such plots may be better described as representing the actual respective engine rotational speeds subsequent to dwell time interval 360.

Moreover, while FIG. 3 illustrates each of spool-up time interval 350 and dwell time interval 360 as being identical for each of first engine target acceleration profile 307 and second engine target acceleration profile 308, this is not required of all examples of the engine startup process. In particular, in some examples, the engine startup process and/or engine target acceleration profile 306 is configured such that the transition from spool-up time interval 350 to dwell time interval 360 takes place at a moment in time corresponding to a time at which the engine rotational speed represented by engine target acceleration profile 306 enters and/or falls within engine starting speed envelope 330. Accordingly, in some examples, distinct examples of engine target acceleration profile 306 correspond to distinct moments in time in which the engine startup process transitions from spool-up time interval 350 to dwell time interval 360.

FIG. 3 additionally illustrates examples in which each of first engine target acceleration profile 307 and second engine target acceleration profile 308 departs from maximum engine acceleration profile 304, such as would be produced if engine starter 200 were operated according to maximum starter torque curve 300, within dwell time interval 360. Accordingly, in some examples, gas turbine engine starter system 100 is configured such that speed-dependent regulated torque value 312 of the starter torque is less than speed-dependent maximum torque value 302 of the starter torque at each starter rotational speed of a set, sequence, and/or interval of starter rotational speeds that are produced during at least a portion of dwell time interval 360.

With continued reference to FIG. 3, the engine startup process further may be characterized by a maximum torque interval 370 that initiates immediately subsequent to the end of dwell time interval 360. In particular, in some examples, gas turbine engine starter system 100 is configured to operate engine starter 200 such that the value of the starter torque generated by engine starter 200 (e.g., speed-dependent regulated torque value 312) is equal to speed-dependent maximum torque value 302 associated with engine starter 200 during maximum torque interval 370. In such examples, gas turbine engine starter system 100 may be described as operating according to an open-loop control routine in which engine starter 200 operates to produce the starter torque without restriction. In particular, in some examples, the end of dwell time interval 360 corresponds to and/or sequentially follows a circumstance in which the combustion process within combustion chamber 150 has been successfully initiated. At this point in such examples, and as illustrated in FIG. 3, the engine rotational speed of gas turbine engine 110 accelerates toward a steady-state operational engine rotational speed 340 that represents and/or characterizes operative use of gas turbine engine 110 (e.g., operation independent of gas turbine engine starter system 100).

In some examples, operating engine starter 200 to provide the starter torque to gas turbine engine 110 subsequent to dwell time interval 360 facilitates the acceleration of the engine rotational speed toward steady-state operational engine rotational speed 340. In particular, because maximum torque interval 370 corresponds to a time interval in which stable combustion has been initiated within combustion chamber 150 in some examples, the benefit to regulating speed-dependent regulated torque value 312 to be below speed-dependent maximum torque value 302 is at least partially obviated within this time interval. Accordingly, in such examples, there is relatively little or no consequence to operating engine starter 200 in a manner that delivers a maximum available amount of the starter torque to gas turbine engine 110 within maximum torque interval 370.

Moreover, in some examples, the operation of engine starter 200 within maximum torque interval 370 corresponds to an operational regime in which speed-dependent maximum torque value 302 is significantly lower than the corresponding value during operation within spool-up time interval 350 and/or dwell time interval 360. Accordingly, in such examples, operating engine starter 200 to produce speed-dependent maximum torque value 302 within maximum torque interval 370 nonetheless represents producing a lower value of the starter torque than during operation within spool-up time interval 350 and/or dwell time interval 360.

Returning to FIG. 2, gas turbine engine starter system 100 and/or gas turbine engine 110 may include any of a variety of components for enabling and/or facilitating the operation described herein. For example, in some examples, and as schematically illustrated in FIG. 2, gas turbine engine 110 includes a fuel pump 176 that is configured to convey fuel flow 178 to combustion chamber 150.

Additionally or alternatively, in some examples, and as schematically illustrated in FIG. 2, gas turbine engine 110 includes an ignition system 170 that is configured to initiate combustion of air-fuel mixture 134 within combustion chamber 150. In particular, in some such examples, and as schematically illustrated in FIG. 2, ignition system 170 includes an exciter 172 and an ignitor plug 174. In such examples, ignitor plug 174 is configured to produce an electrical spark to ignite air-fuel mixture 134, and exciter 172 is configured to convey a high-voltage electrical signal to ignitor plug 174 to produce the electrical spark.

Engine starter 200 may be operatively coupled to gas turbine engine 110 in any of a variety of manners. In some examples, starter torque output 202 is operatively coupled to engine shaft 120 and/or to powerhead compressor 140. In particular, in some examples, starter torque output 202 is operatively coupled to powerhead compressor 140 via engine shaft 120 in order to convey the starter torque to powerhead compressor 140 via engine shaft 120.

In some examples, and as schematically illustrated in FIG. 2, gas turbine engine starter system 100 additionally includes a gearbox 102 that operatively interconnects starter torque output 202 and gas turbine engine 110. In particular, in some such examples, gearbox 102 is operatively coupled to engine shaft 120. In some examples, gearbox 102 operatively interconnects starter torque output 202 and gas turbine engine 110 such that a rotation of starter torque output 202 at the starter rotational speed yields a rotation of a component of gas turbine engine 110, such as engine shaft 120 and/or powerhead compressor 140, at the engine rotational speed. More specifically, in some such examples, gearbox 102 is characterized by a gear ratio such that the engine rotational speed is different than the starter rotational speed.

In some examples, and as schematically illustrated in FIG. 2, engine starter 200 includes a one-way clutch mechanism 220 such that starter motor 210 is operatively coupled to starter torque output 202 via one-way clutch mechanism 220. In particular, in such examples, one-way clutch mechanism 220 operates to prevent gas turbine engine 110 from driving starter motor 210. Stated differently, when present, one-way clutch mechanism 220 operates to permit engine starter 200 to convey the starter torque from starter motor 210 to gas turbine engine 110 via starter torque output 202 and to prevent gas turbine engine 110 from conveying a torque to starter motor 210 via starter torque output 202. However, this is not required of all examples of engine starter 200, and it additionally is within the scope of the present disclosure that engine starter 200 may be configured to receive a torque from gas turbine engine 110. In particular, in some examples, and as schematically illustrated in FIG. 2, starter motor 210 includes a starter generator 230 that is configured to receive a torque from starter torque output 202 and to generate an electrical current, such as during self-sustaining operation of gas turbine engine 110. That is, in such examples, starter generator 230 is configured to receive a torque from gas turbine engine 110 via starter torque output 202, such as while gas turbine engine 110 is in operative use to generate the engine torque.

As used herein, the term “operatively coupled,” as used to describe a functional, structural, and/or mechanical relationship between two or more components of gas turbine engine 110 and/or of engine starter 200, is intended to refer to any configuration in which the two or more components are directly and/or indirectly coupled to one another via one or more structural components. As an example, starter motor 210 of engine starter 200 may be described as being operatively coupled to powerhead compressor 140 of gas turbine engine 110 in any of a variety of examples in which torque may be transferred from starter motor 210 to powerhead compressor 140, such as via one-way clutch mechanism 220, starter torque output 202, gearbox 102, and/or engine shaft 120.

Engine starter 200 may be configured to produce the starter torque in any of a variety of manners. In some examples, and as schematically illustrated in FIG. 2, gas turbine engine starter system 100 includes a starter power supply 104 that is configured to provide electrical power to engine starter 200 to produce the starter torque. In some such examples, and as schematically illustrated in FIG. 2, starter power supply 104 is spatially removed from (e.g., spaced apart from) engine starter 200 and from gas turbine engine 110.

In some examples, and as schematically illustrated in FIG. 2, gas turbine engine starter system 100 includes an engine controller 190 that is programmed to generate and transmit a starter control signal 192 to at least partially control operation of engine starter 200. In particular, in various examples, engine controller 190 is programmed to generate starter control signal 192 such that the engine rotational speed follows engine target acceleration profile 306 during at least a portion of the engine startup process. Specifically, in various examples, engine controller 190 is programmed to generate starter control signal 192 such that the engine rotational speed follows engine target acceleration profile 306 during at least a portion of spool-up time interval 350, during at least a portion of dwell time interval 360, and/or during at least a portion of maximum torque interval 370. Additionally or alternatively, in some examples, engine controller 190 is programmed to generate starter control signal 192 such that the engine rotational speed remains within engine starting speed envelope 330 during dwell time interval 360, as described herein. As described in more detail herein, gas turbine engine starter system 100 is configured such that starter control signal 192 may be selectively and/or dynamically varied, modulated, and/or regulated during the engine startup process. In particular, in various examples, active regulation and/or variation of starter control signal 192 enables a corresponding regulation and/or variation of the engine rotational speed, such as to ensure that the engine rotational speed follows engine target acceleration profile 306 and/or such that the engine rotational speed remains within engine starting speed envelope 330. Accordingly, as used herein, starter control signal 192 also may be referred to as a variable starter control signal 192.

In some examples, engine controller 190 is programmed to generate starter control signal 192 such that speed-dependent regulated torque value 312 of the starter torque that is produced by engine starter 200 is less than speed-dependent maximum torque value 302 of the starter torque at each starter rotational speed of a set, sequence, and/or interval of starter rotational speeds that are produced during at least a portion of spool-up time interval 350. Additionally or alternatively, in some examples, engine controller 190 is programmed to generate starter control signal 192 such that speed-dependent regulated torque value 312 of the starter torque is less than speed-dependent maximum torque value 302 of the starter torque at each starter rotational speed of a set, sequence, and/or interval of starter rotational speeds that are produced during at least a portion of dwell time interval 360.

Additionally or alternatively, in some examples, and as discussed, engine controller 190 is programmed to generate starter control signal 192 to regulate operation of engine starter 200 during at least a portion of maximum torque interval 370. In particular, in some examples, engine controller 190 is programmed to generate starter control signal 192 such that speed-dependent regulated torque value 312 of the starter torque is equal to speed-dependent maximum torque value 302 of the starter torque during at least a portion of maximum torque interval 370.

Additionally or alternatively, in some examples, engine controller 190 further is programmed to terminate operation of engine starter 200 to produce the starter torque in certain conditions. More specifically, in some examples, and with reference to FIG. 3, engine controller 190 is programmed to generate starter control signal 192 such that maximum torque interval 370 terminates (e.g., as a result of engine starter 200 ceasing to generate the starter torque) when the engine rotational speed reaches a threshold cutoff speed 342 that is a threshold percentage of steady-state operational engine rotational speed 340. In particular, FIG. 3 illustrates a manner in which two distinct engine target acceleration profiles 306 (e.g., first engine target acceleration profile 307 and second engine target acceleration profile 308) may yield correspondingly distinct durations of maximum torque interval 370 based upon the time at which the engine rotational speed represented each engine target acceleration profile 306 reaches threshold cutoff speed 342. The threshold percentage of steady-state operational engine rotational speed 340 that is represented by threshold cutoff speed 342 may be any of a variety of percentages, examples of which include at least 30%, at least 40%, at least 50%, at least 60%, at most 70%, at most 55%, at most 45%, and at most 35%. In the example of FIG. 3, the threshold percentage is about 50%.

Additionally or alternatively, in some examples, engine controller 190 is programmed to determine engine target acceleration profile 306, such as based upon a measured and/or calculated condition of gas turbine engine starter system 100, of engine starter 200, and/or of gas turbine engine 110. As discussed, gas turbine engine starter system 100 generally is configured to operate engine starter 200 to accelerate the engine rotational speed according to engine target acceleration profile 306, which in turn may be selected, predetermined, calculated, generated, etc. prior to initiation of the engine startup process based upon any of a variety of factors. Accordingly, in some examples, and as described in more detail herein, engine controller 190 is configured to determine (e.g., to generate, calculate, and/or select) engine target acceleration profile 306 based upon one or more measured and/or calculated conditions.

In some examples, and as schematically illustrated in FIG. 2, starter control signal 192 includes and/or is an electrical power signal 194 that powers engine starter 200 and/or starter motor 210. In particular, in some such examples, engine controller 190 is programmed to modulate an electrical current and/or an electrical voltage of electrical power signal 194 to regulate operation of engine starter 200 and/or of starter motor 210. In some such examples, electrical power signal 194 includes and/or is an electrical current and/or an electrical voltage that is provided by starter power supply 104.

In some examples, and as schematically illustrated in FIG. 2, engine controller 190 is programmed to transmit starter control signal 192 to engine starter 200, such as by transmitting starter control signal 192 directly to starter motor 210. That is, in some such examples, engine controller 190 is programmed to transmit starter control signal 192 to engine starter 200 such that starter control signal 192 powers starter motor 210 in such a manner that the engine rotational speed follows engine target acceleration profile 306. Additionally or alternatively, in some examples, and as schematically illustrated in FIG. 2, gas turbine engine starter system 100 additionally includes a starter controller 240 that is programmed and/or configured to at least partially control operation of starter motor 210, and engine controller 190 is programmed to transmit starter control signal 192 to starter controller 240. When present, starter controller 240 may include and/or be any of a variety of controllers, examples of which include a software-based controller and an electronic hardware circuit. In some examples, engine starter 200 includes starter controller 240.

When present, starter controller 240 may operate in any of a variety of manners to control operation of starter motor 210, such as based upon starter control signal 192. In some examples, starter controller 240 is configured to transmit, convey, and/or relay electrical power signal 194 to starter motor 210 to power engine starter 200. In some such examples, and as discussed, electrical power signal 194 is a signal with an electrical current and/or an electrical voltage that is modulated by engine controller 190 to produce a commanded starter torque. Additionally or alternatively, in some examples, starter controller 240 is configured to vary the electrical current and/or the electrical voltage of electrical power signal 194 to regulate operation of engine starter 200.

Engine controller 190 and/or starter controller 240 each may be any suitable device or devices that are configured to perform the functions of the controller discussed herein. For example, engine controller 190 and/or starter controller 240 each may include one or more of an electronic controller, a dedicated controller, a special-purpose controller, a personal computer, a special-purpose computer, a display device, a logic device, a memory device, and/or a memory device having non-transitory computer readable media suitable for storing computer-executable instructions for implementing aspects of systems and/or methods according to the present disclosure.

Additionally or alternatively, engine controller 190 and/or starter controller 240 each may include, or be configured to read, non-transitory computer readable storage, or memory, media suitable for storing computer-executable instructions, or software, for implementing methods or steps of methods according to the present disclosure. Examples of such media include CD-ROMs, disks, hard drives, flash memory, etc. As used herein, storage, or memory, devices and media having computer-executable instructions as well as computer-implemented methods and other methods according to the present disclosure are considered to be within the scope of subject matter deemed patentable in accordance with Section 101 of Title 35 of the United States Code.

Engine controller 190 may be configured to generate starter control signal 192 in any of a variety of manners and/or based upon any of a variety of factors. In particular, in various examples, and as discussed, engine controller 190 is programmed to generate starter control signal 192 such that the engine rotational speed follows engine target acceleration profile 306 during at least a portion of the engine startup process. Accordingly, in such examples, gas turbine engine starter system 100 may be configured to provide engine controller 190 with any of a variety of inputs such that starter control signal 192 operates to command engine starter 200 to produce a starter torque that yields an engine rotational speed according to engine target acceleration profile 306. Additionally or alternatively, engine controller 190 may be programmed to determine and/or generate engine target acceleration profile 306 in any of a variety of manners and/or based upon any of a variety of factors, such as may be based upon any of a variety of inputs provided to engine controller 190.

In some examples, and as schematically illustrated in FIG. 2, engine controller 190 is programmed to receive a gas turbine engine status signal 112 that represents an operating condition of gas turbine engine 110. In such examples, starter control signal 192 is at least partially based upon gas turbine engine status signal 112. Gas turbine engine status signal 112 may represent any of a variety of operational conditions associated with gas turbine engine 110.

In some examples, and as schematically illustrated in FIG. 2, gas turbine engine status signal 112 includes an engine speed signal 124 that represents the engine rotational speed. In particular, in some such examples, and as schematically illustrated in FIG. 2, gas turbine engine 110 includes an engine speed sensor 122 that is configured to measure the engine rotational speed and to generate engine speed signal 124. In some such examples, engine speed sensor 122 is operatively coupled to engine shaft 120. Accordingly, in some examples in which gas turbine engine status signal 112 includes engine speed signal 124, engine controller 190 is configured to generate starter control signal 192 at least partially based upon engine speed signal 124. In particular, in some such examples, engine controller 190 is programmed to generate starter control signal 192 at least partially based upon the measured engine rotational speed (e.g., as measured in real time) and/or upon a measured acceleration of the engine rotational speed (e.g., as determined based on a series of real-time measurements of the engine rotational speed). Accordingly, such functionality facilitates generating starter control signal 192 in a manner that regulates the engine rotational speed at least partially based upon the measured engine rotational speed, thereby forming a feedback mechanism. Additionally or alternatively, in some examples, engine controller 190 is programmed to repeatedly update starter control signal 192 during spool-up time interval 350 and/or during dwell time interval 360, such as to ensure that the engine rotational speed follows engine target acceleration profile 306 during at least a portion of the engine startup process. In examples in which starter control signal 192 is at least partially based upon the measured engine rotational speed, gas turbine engine starter system 100 may be described as operating according to a closed-loop control routine. That is, in such examples, the measurement of the engine rotational speed enables gas turbine engine starter system 100 to utilize a feedback loop to regulate the engine rotational speed to match and/or follow engine target acceleration profile 306.

Additionally or alternatively, in some examples, gas turbine engine status signal 112 is at least partially based upon, and/or represents, a temperature associated with gas turbine engine 110. In particular, in some examples, and as schematically illustrated in FIG. 2, gas turbine engine status signal 112 include an exhaust gas temperature (EGT) signal 184 that represents an EGT of combustion gases 136 as combustion gases 136 are exhausted from gas turbine engine 110. More specifically, in some such examples, gas turbine engine starter system 100 includes an EGT sensor 182 that is configured to measure the EGT of combustion gases 136 as combustion gases 136 are exhausted from gas turbine engine 110 and to generate and transmit EGT signal 184. When present, EGT sensor 182 may be positioned at any suitable location relative to gas turbine engine 110 and/or components thereof. In particular, in some examples, and as schematically illustrated in FIG. 2, EGT sensor 182 is positioned downstream of powerhead turbine 160 (e.g., with respect to the flow of combustion gases 136) and/or within exhaust outlet 180.

In some examples in which gas turbine engine status signal 112 includes EGT signal 184, engine controller 190 is programmed to generate starter control signal 192 at least partially based upon EGT signal 184. In particular, in some examples, the EGT that is measured by EGT sensor 182 is indicative of the state and/or status of the combustion process occurring within combustion chamber 150. Accordingly, in some examples, an indication that the EGT is rising significantly and/or rapidly is indicative of the initiation of a stable and/or self-sustaining combustion process within combustion chamber 150, which in turn may signal and/or prompt a transition from dwell time interval 360 to maximum torque interval 370. In this manner, in some such examples, the duration of dwell time interval 360 is not predetermined or prescribed, but instead is determined and/or defined within an given instance and/or execution of the engine startup process based upon the indication from EGT sensor 182 that the EGT is rising in a manner consistent with stable and/or self-sustaining combustion within combustion chamber 150.

Additionally or alternatively, in some examples, and as schematically illustrated in FIG. 2, gas turbine engine status signal 112 includes an oil temperature signal 188 that represents a temperature of an oil (e.g., an engine oil and/or a gearbox oil) that is utilized by, and/or in conjunction with, gas turbine engine 110. In particular, in some examples, and as schematically illustrated in FIG. 2, gas turbine engine starter system 100 includes an oil temperature sensor 186 that is configured to generate and transmit oil temperature signal 188. When present, oil temperature sensor 186 may be positioned at any suitable location relative to gas turbine engine 110 and/or components thereof. In particular, in some examples, and as schematically illustrated in FIG. 2, oil temperature sensor 186 is operatively coupled to gearbox 102.

In some examples in which gas turbine engine status signal 112 includes oil temperature signal 188, engine controller 190 is programmed to generate starter control signal 192 at least partially based upon oil temperature signal 188. In particular, in some examples, the oil temperature that is measured by oil temperature sensor 186 is indicative of a state of gas turbine engine 110 in a manner that may inform the selection and/or determination of engine target acceleration profile 306. As a more specific example, and as discussed, the selection and/or determination of engine target acceleration profile 306 may be performed such that, when gas turbine engine 110 is comparatively cold (as characterized, for example, by a comparatively low temperature indicated by oil temperature signal 188), engine target acceleration profile 306 represents a comparatively gradual acceleration of the engine rotational speed within spool-up time interval 350 and/or a comparatively low engine starting rotational speed 332 within dwell time interval 360. Accordingly, in some examples, engine controller 190 is programmed to determine engine target acceleration profile 306 at least partially based upon gas turbine engine status signal 112 and/or oil temperature signal 188.

Additionally or alternatively, in some examples, engine controller 190 is programmed to generate starter control signal 192 at least partially based upon a measured, calculated, and/or indicated state and/or status of engine starter 200. In particular, in some examples, and as schematically illustrated in FIG. 2, starter controller 240 is configured to generate a starter status signal 242 that represents an operating condition of engine starter 200 and to transmit starter status signal 242 to engine controller 190. Accordingly, in some such examples, starter control signal 192 as generated by engine controller 190 is at least partially based upon starter status signal 242.

When utilized, starter status signal 242 may represent any of a variety of conditions associated with engine starter 200. In particular, in some examples, starter status signal 242 represents the starter rotational speed, a temperature of engine starter 200, maximum starter torque curve 300 associated with and/or characterizing engine starter 200, and/or an actual (e.g., real-time) value of the starter torque that is produced by engine starter 200. For example, in examples in which starter status signal 242 represents the starter rotational speed, maximum starter torque curve 300, and/or the actual value of the starter torque as produced by engine starter 200, such information thus may enable and/or facilitate generating starter control signal 192 to command engine starter 200 to produce a starter torque that is less than speed-dependent maximum torque value 302 corresponding to the indicated starter rotational speed. Additionally or alternatively, in some examples, engine controller 190 is programmed to determine engine target acceleration profile 306 at least partially based upon starter status signal 242, such as to ensure that engine target acceleration profile 306 corresponds to a functional capability of engine starter 200 as characterized by maximum starter torque curve 300.

Additionally or alternatively, in some examples, engine controller 190 is programmed to generate starter control signal 192 at least partially based upon a measured, calculated, and/or indicated state of vehicle 10 that includes and/or utilizes gas turbine engine starter system 100. In particular, in some examples, and as schematically illustrated in FIG. 2, vehicle 10 includes one or more vehicle status sensors 22, each of which is configured to generate and transmit a respective portion of a vehicle status signal 24 that represents an operational condition of vehicle 10. In various examples, vehicle status signal 24 thus represents any of a variety of conditions, such as an ambient temperature of air surrounding vehicle 10, an ambient pressure of air surrounding vehicle 10, a speed at which vehicle 10 is traveling, an altitude at which vehicle 10 is traveling, etc. Accordingly, in some such examples, engine controller 190 is programmed to generate starter control signal 192 and/or to determine engine target acceleration profile 306 at least partially based upon vehicle status signal 24.

For example, in some examples, engine controller 190 may be programmed to determine engine target acceleration profile 306 in such a manner that a comparatively low ambient temperature of air surrounding vehicle 10 corresponds to accelerating the engine rotational speed comparatively gradually within spool-up time interval 350 and/or maintaining the engine rotational speed at a comparatively low engine starting rotational speed 332 within dwell time interval 360.

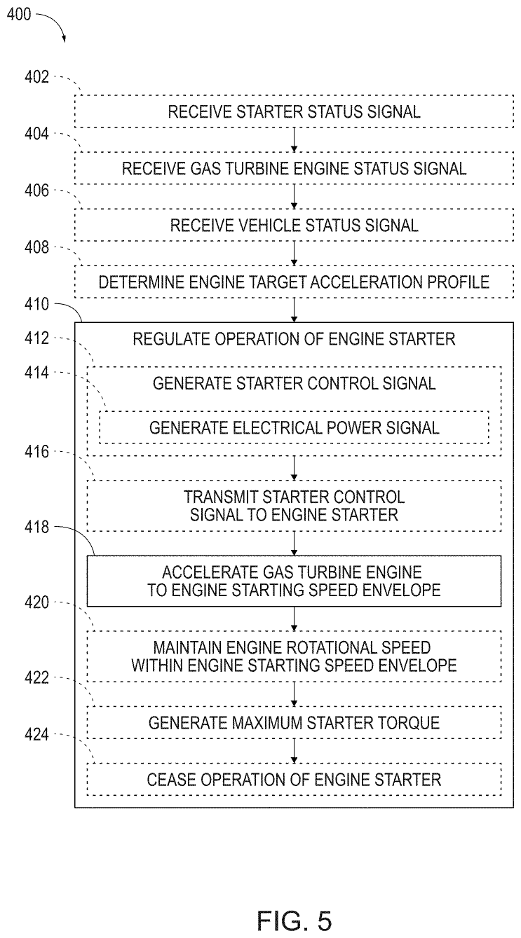

FIG. 5 is a flowchart representing examples of methods 400 of operating a gas turbine engine starter system, such as gas turbine engine starter system 100 disclosed herein. In particular, methods 400 pertain to the operation of gas turbine engine starter systems to initiate operation of a gas turbine engine during an engine startup process. A gas turbine engine starter system utilized in conjunction with methods 400 includes an engine starter configured to generate a starter torque during the engine startup process to initiate operation of the gas turbine engine. A gas turbine engine starter system utilized in conjunction with methods 400 additionally includes an engine controller that is programmed to generate and transmit a starter control signal to the engine starter. Examples of engine starters and/or of engine controllers that may be utilized in conjunction with methods 400 are disclosed herein with reference to engine starter 200 and/or engine controller 190, respectively.

As shown in FIG. 5, a method 400 of operating a gas turbine engine starter system includes regulating, at 410 and with the engine controller, the operation of the engine starter. In particular, and as shown in FIG. 5, the regulating the operation of the engine starter at 410 includes accelerating, at 418, the gas turbine engine to bring an engine rotational speed of the gas turbine engine to within an engine starting speed envelope. The engine starting speed envelope encompasses a range of engine starting rotational speeds corresponding to initiation of a combustion process within the gas turbine engine during the engine startup process. In particular, the accelerating the gas turbine engine at 418 includes operating the engine starter such that, during at least a portion of a spool-up time interval of the engine startup process, the starter torque is less than a speed-dependent maximum torque value of the starter torque that the engine starter is configured to produce. Specifically, the spool-up time interval corresponds to a time interval in which the engine rotational speed increases from a non-operative engine rotational speed (e.g., zero, approximately zero, and/or a negligible engine rotational speed) to a speed within the engine starting speed envelope.

In the present disclosure, a process of accelerating the gas turbine engine equivalently may be described as a process of accelerating the engine rotational speed, of changing the engine rotational speed, of modulating the engine rotational speed, of increasing the engine rotational speed, and/or of decreasing the engine rotational speed. Examples of engine starting speed envelopes and/or of engine starting rotational speeds are disclosed herein with reference to engine starting speed envelope 330 and/or engine starting rotational speed 332, respectively. Examples of spool-up time intervals that may be utilized in conjunction with methods 400 are disclosed herein with reference to spool-up time interval 350.

In the present disclosure, methods 400 generally pertain to a set and/or sequence of steps that are performed during the engine startup process (e.g., during a particular instance and/or execution of the engine startup process). In some examples, methods 400 are performed entirely within the engine startup process. However, this is not required of all examples of methods 400, and it additionally is within the scope of the present disclosure that one or more steps of methods 400 are performed prior to or subsequent to the engine startup process. Additionally, while FIG. 5 illustrates a sequential series of steps, it is to be understood that the order of the steps may vary from the order illustrated in FIG. 5, and it is within the scope of the present disclosure that the steps illustrated in FIG. 5 may be performed in any appropriate sequence, concurrently, and/or repeatedly.

As discussed, methods 400 include operating the engine starter to produce a starter torque that is less than a maximum torque that the engine starter is capable of producing at a particular starter rotational speed. In some examples, the engine starter is configured to produce a speed-dependent regulated torque value of the starter torque during operative use of the gas turbine engine starter system. In particular, in some such examples, the regulating the operation of the engine starter at 410 includes regulating such that, at each starter rotational speed of an interval of starter rotational speeds that are produce during at least a portion of the spool-up time interval, the speed-dependent regulated torque value is less than the speed-dependent maximum torque value. Examples of speed-dependent regulated torque values that may be utilized in conjunction with methods 400 are disclosed herein with reference to speed-dependent regulated torque value 312, such as may be represented and/or characterized by regulated starter torque curve 310.

The regulating the operation of the engine starter at 410 may include regulating in any of a variety of manners, such as based up any of a variety of sensed, measured, and/or calculated conditions and/or factors. In some examples, and as shown in FIG. 5, the regulating the operation of the engine starter at 410 includes generating, at 412 and with the engine controller, the starter control signal and/or transmitting, at 416 and with the engine controller, the starter control signal to the engine starter. In such examples, the generating the starter control signal at 412 may include generating the starter control signal to take any of a variety of forms. In some examples, and as shown in FIG. 5, the generating the starter control signal at 412 includes generating, at 414, an electrical power signal that powers the engine starter. In particular, in some such examples, the generating the starter control signal at 412 and/or the generating the electrical power signal at 414 includes modulating an electrical current and/or an electrical voltage of the electrical power signal, such as to modulate the starter torque produced by the engine starter in a corresponding manner. Examples of electrical power signals that may be utilized in conjunction with methods 400 are disclosed herein with reference to electrical power signal 194.

The transmitting the starter control signal at 416 may be performed in any of a variety of manners. In particular, in some examples, the engine starter includes a starter motor that is configured to produce the starter torque (such as starter motor 210 disclosed herein), and the transmitting the starter control signal at 416 includes transmitting the starter control signal directly to the starter motor.

In some such examples, the transmitting the starter control signal at 416 includes transmitting the electrical power signal to the starter motor, such as to power the starter motor with the starter control signal and/or with the electrical power signal. Additionally or alternatively, in some examples, the gas turbine engine starter system includes a starter controller configured to at least partially control operation of the engine starter, such as starter controller 240 disclosed herein. In some such examples, the transmitting the starter control signal at 416 includes transmitting the starter control signal to the starter controller.

In some examples, the generating the starter control signal at 412 includes generating such that the engine rotational speed follows a selected predetermined engine target acceleration profile during at least a portion of the spool-up time interval. Examples of selected predetermined engine target acceleration profiles that may be utilized in conjunction with methods 400 are disclosed herein with reference to selected predetermined engine target acceleration profile 306. In this manner, in such examples, and as described herein, the gas turbine engine starter system is configured to operate the engine starter in such a manner that the engine rotational speed of the gas turbine engine varies in time in a manner consistent with the selected predetermined engine target acceleration profile. In particular, in some examples, the generating the starter control signal at 412 includes repeatedly updating the starter control signal during the spool-up time interval such that engine rotational speed follows the selected predetermined engine target acceleration profile during at least a portion of the spool-up time interval.

The selected predetermined engine target acceleration profile that is utilized in conjunction with methods 400, such as during a particular instance and/or execution of the engine startup process, may be selected and/or determined in any of a variety of manners. In some examples, and as shown in FIG. 5, the regulating the operation of the engine starter at 410 includes determining, at 408 and with the engine controller, the selected predetermined engine target acceleration profile. In such examples, the determining the selected predetermined engine target acceleration profile at 408 may performed based on any of a variety of calculated and/or measured factors, conditions, and/or criteria, such as may be based upon one or more status signals that are received by the engine controller. In particular, in some examples, and as shown in FIG. 5, methods 400 additionally include receiving, at 402 and with the engine controller, a starter status signal that represents an operating condition of the engine starter. In some such examples, one or more of the determining the selected predetermined engine target acceleration profile at 408, the regulating the operation of the engine starter at 410, and/or the generating the starter control signal at 412 are at least partially based upon the starter status signal. Examples of starter status signals that may be utilized in conjunction with methods 400 are disclosed herein with reference to starter status signal 242.

Additionally or alternatively, in some examples, and as shown in FIG. 5, methods 400 additionally include receiving, at 404 and with the engine controller, a gas turbine engine status signal that represents an operating condition of the gas turbine engine. In some such examples, one or more of the determining the selected predetermined engine target acceleration profile at 408, the regulating the operation of the engine starter at 410, and/or the generating the starter control signal at 412 is at least partially based upon the gas turbine engine status signal. In particular, in some examples, the receiving the gas turbine engine status signal at 404 includes receiving an engine speed signal from an engine speed sensor such that the engine speed signal represents the engine rotational speed. In some such examples, the generating the starter control signal at 412 is performed at least partially via a closed-loop feedback control routine in which the starter control signal is repeatedly and/or continuously generated so as to regulate the measured engine rotational speed and/or an acceleration of the measured engine rotational speed according to the selected predetermined engine target acceleration profile. In this manner, in some examples, the receiving the gas turbine engine status signal at 404 and the generating the starter control signal at 412 are performed at least partially concurrently, repeatedly, and/or continuously. Examples of gas turbine engine status signals, of engine speed sensors, and/or of engine speed signals that may be utilized in conjunction with methods 400 are disclosed herein with reference to gas turbine engine status signal 112, engine speed sensor 122, and/or engine speed signal 124, respectively.

Additionally or alternatively, in some examples, the gas turbine engine is incorporated into a vehicle that includes one or more vehicle status sensors, each of which is configured to generate and transmit a respective portion of a vehicle status signal that represents an operational condition of the vehicle. In some such examples, and as shown in FIG. 5, methods 400 additionally include receiving, at 406 and with the engine controller, the vehicle status signal. In some such examples, one or more of the determining the selected predetermined engine target acceleration profile at 408, the regulating the operation of the engine starter at 410, and/or the generating the starter control signal at 412 is at least partially based upon the vehicle status signal. Examples of vehicles, vehicle status sensors, and/or vehicle status signals that may be utilized in conjunction with methods 400 are disclosed herein with reference to vehicle 10, vehicle status sensor 22, and/or vehicle status signal 24, respectively.

In some examples, methods 400 include operating the engine starter such that the engine rotational speed of the gas turbine engine remains within a range of engine rotational speeds that is conducive to initiation of stable and/or self-sustaining combustion within the gas turbine engine for a period of time. In particular, in some examples, and as shown in FIG. 5, the regulating the operation of the engine starter at 410 includes maintaining, at 420, the engine rotational speed within the engine starting speed envelope during a dwell time interval of the engine startup process. In particular, in such examples, the dwell time interval is an interval of time that initiates immediately subsequent to the end of the spool-up time interval. Examples of dwell time intervals that may be utilized in conjunction with methods 400 are disclosed herein with reference to dwell time interval 360.

In some examples in which methods 400 include the maintaining the engine rotational speed within the engine starting speed envelope at 420, methods 400 include regulating the operation of the engine starter such that the engine rotational speed remains within the engine starting speed envelope during the dwell time interval. In particular, in some examples, the regulating the operation of the engine starter at 410 includes generating the starter control signal such that, at each starter rotational speed of an interval of starter rotational speeds produced during at least a portion of the dwell time interval, the speed-dependent regulated torque value of the starter torque produced by the engine starter is less than the speed-dependent maximum torque value of the starter torque. In some such examples, the generating the starter control signal at 412 includes repeatedly updating the starter control signal during the dwell time interval such that the engine rotational speed remains within the engine starting speed envelope during the dwell time interval.

In some examples, methods 400 additionally include operating the engine starter to continue to provide the starter torque to the gas turbine engine after the dwell time interval, such as after initiation of a combustion process within the gas turbine engine. In particular, in some examples, and as shown in FIG. 5, the regulating the operation of the engine starter at 410 includes, subsequent to the maintaining the engine rotational speed within the engine starting speed envelope at 420, generating, at 422 and with the engine starter, a maximum starter torque during a maximum torque interval of the engine startup process. In particular, in such examples, the maximum torque interval begins immediately subsequent to the dwell time interval. More specifically, in some such examples, the generating the maximum starter torque at 422 includes performing the generating the starter control signal at 412 such that the speed-dependent regulated torque value of the starter torque is equal to the speed-dependent maximum torque value of the starter torque during the maximum torque interval. Examples of maximum torque intervals that may be utilized in conjunction with methods 400 are disclosed herein with reference to maximum torque interval 370. In some examples, the generating the maximum starter torque at 422 may be described as operating the gas turbine engine starter system according to an open-loop control routine.

In some examples, the generating the maximum starter torque at 422 is performed responsive to an indication that the gas turbine engine has initiated operation, and/or that stable and/or self-sustaining combustion has initiated within the gas turbine engine. In such examples, the generating the maximum starter torque at 422 may be performed responsive to any such indication. In particular, in some examples, the receiving the gas turbine engine status signal at 404 includes receiving an exhaust gas temperature (EGT) signal that indicates an EGT of combustion gases that are generated by the gas turbine engine. Accordingly, in some such examples, the generating the maximum starter torque at 422 is performed responsive of the EGT signal indicating that the EGT exceeds a threshold EGT, such as may be indicative of the initiation of stable and/or self-sustaining combustion within the gas turbine engine. Examples of combustion gases and/or of EGT signals that may be utilized in conjunction with methods 400 are disclosed herein with reference to combustion gases 136 and/or EGT signal 184, respectively. In some examples, the EGT signal is generated by an EGT sensor, such as EGT sensor 182 disclosed herein.

In some examples, and as shown in FIG. 5, the regulating the operation of the engine starter at 410 additionally includes ceasing, at 424, the operation of the engine starter to provide the starter torque to the gas turbine engine. In such examples, the ceasing the operation of the engine starter at 424 may be performed in any of a variety of manners, such as by ceasing to transmit the starter control signal to the engine starter, and/or by transmitting a starter control signal that commands the engine starter to reduce the starter torque to zero.

Additionally, the ceasing the operation of the engine starter at 424 may be performed at any suitable point in the engine startup process. In some examples, the ceasing the operation of the engine starter at 424 is performed at the end of the maximum torque interval. Additionally or alternatively, in some examples, the ceasing the operation of the engine starter at 424 is performed responsive to the gas turbine engine status signal indicating that the engine rotational speed has reached a threshold cutoff speed that is a threshold percentage of a steady-state operational engine rotational speed associated with the gas turbine engine. In some such examples, the threshold percentage is at least 30%, at least 40%, at least 50%, at least 60%, at most 70%, at most 55%, at most 45%, and at most 35%. That is, in some examples, the indication that the engine rotational speed has reached the threshold cutoff speed defines and/or signals the end of the maximum torque interval, which in turn coincides with the ceasing the operation of the engine starter at 424. Examples of threshold cutoff speeds and/or of steady-state operational engine rotational speeds that may be utilized in conjunction with methods 400 are disclosed herein with reference to threshold cutoff speed 342 and/or steady-state operational engine rotational speed 340, respectively.

Illustrative, non-exclusive examples of inventive subject matter according to the present disclosure are described in the following enumerated paragraphs:

A1. A gas turbine engine starter system (100) for initiating operation, during an engine startup process, of a gas turbine engine (110) that includes an engine shaft (120) that is configured to rotate at an engine rotational speed, the gas turbine engine starter system (100) comprising:

an engine starter (200) configured to generate a starter torque during the engine startup process to initiate operation of the gas turbine engine (110) to produce an engine torque;

wherein the engine starter (200) includes a starter torque output (202) that is configured to rotate at a starter rotational speed and to convey the starter torque to the gas turbine engine (110) during the engine startup process to initiate operation of the gas turbine engine (110);

wherein the gas turbine engine (110) is characterized by an engine starting speed envelope (330) that encompasses a range of engine starting rotational speeds (332) corresponding to initiation of a combustion process within the gas turbine engine (110) during the engine startup process; wherein the engine startup process includes a spool-up time interval (350) in which the engine rotational speed increases from a non-operative engine rotational speed to a speed within the engine starting speed envelope (330); and wherein the gas turbine engine starter system (100) is configured such that, during operative use of the gas turbine engine starter system (100) and during at least a portion of the spool-up time interval (350), the starter torque is less than a speed-dependent maximum torque value (302) of the starter torque that the engine starter (200) is configured to produce.

A2. The gas turbine engine starter system (100) of paragraph A1, wherein the non-operative engine rotational speed is one or more of zero, approximately zero, and a negligible engine rotational speed.

A3. The gas turbine engine starter system (100) of any of paragraphs A1-A2, wherein the engine starter (200) is characterized by a maximum starter torque curve (300) that represents the speed-dependent maximum torque value (302) of the starter torque that the engine starter (200) is configured to produce as a function of the starter rotational speed.

A4. The gas turbine engine starter system (100) of any of paragraphs A1-A3, wherein the engine starter (200) is configured to produce a speed-dependent regulated torque value (312) of the starter torque during operative use of the gas turbine engine starter system (100); and wherein the gas turbine engine starter system (100) is configured such that, during operative use of the gas turbine engine starter system (100), the speed-dependent regulated torque value (312) of the starter torque is less than the speed-dependent maximum torque value (302) of the starter torque at each starter rotational speed of an interval of starter rotational speeds that are produced during at least a portion of the spool-up time interval (350).

A5. The gas turbine engine starter system (100) of paragraph A4, wherein the engine starter (200) is characterized by a regulated starter torque curve (310) during the engine startup process; and wherein the regulated starter torque curve (310) represents the speed-dependent regulated torque value (312) of the starter torque that is produced by the engine starter (200) as a function of the starter rotational speed.

A6. The gas turbine engine starter system (100) of any of paragraphs A1-A5, wherein the gas turbine engine starter system (100) is configured such that the engine starter (200) generates the starter torque such that the engine rotational speed follows a selected predetermined engine target acceleration profile (306) during at least a portion of the spool-up time interval (350).

A7. The gas turbine engine starter system (100) of paragraph A6, wherein the engine rotational speed of the gas turbine engine (110) deviates from the engine rotational speed represented by the selected predetermined engine target acceleration profile (306) within at least a portion of the engine startup process by an average deviation that is one or more of at most 10%, at most 5%, and at most 1%.

A8. The gas turbine engine starter system (100) of any of paragraphs A1-A7, further comprising the gas turbine engine (110).

A9. The gas turbine engine starter system (100) of any of paragraphs A1-A8, wherein the gas turbine engine (110) is operable to produce the engine torque and to convey the engine torque via the engine shaft (120).

A10. The gas turbine engine starter system (100) of any of paragraphs A1-A9, wherein the gas turbine engine (110) includes:

a powerhead compressor (140) configured to compress an engine airflow (132);

a combustion chamber (150) configured to combust an air-fuel mixture (134), which includes a mixture of the engine airflow (132) and a fuel flow (178), to produce combustion gases (136); and

a powerhead turbine (160) configured to extract energy from the combustion gases (136) to produce the engine torque.

A11. The gas turbine engine starter system (100) of paragraph A10, wherein the gas turbine engine (110) further includes a fuel pump (176) configured to convey the fuel flow (178) to the combustion chamber (150).

A12. The gas turbine engine starter system (100) of any of paragraphs A10-A11, wherein the gas turbine engine (110) further includes an ignition system (170) configured to initiate combustion of the air-fuel mixture (134) within the combustion chamber (150).

A13. The gas turbine engine starter system (100) of paragraph A12, wherein the ignition system (170) includes:

an ignitor plug (174) configured to produce an electrical spark to ignite the air-fuel mixture (134); and

an exciter (172) configured to convey a high-voltage electrical signal to the ignitor plug (174).

A14. The gas turbine engine starter system (100) of any of paragraphs A10-A13, wherein the starter torque output (202) is operatively coupled to the powerhead compressor (140) to convey the starter torque to the powerhead compressor (140).

A15. The gas turbine engine starter system (100) of any of paragraphs A10-A14, wherein the starter torque output (202) is operatively coupled to the engine shaft (120).

A16. The gas turbine engine starter system (100) of any of paragraphs A10-A15, wherein the starter torque output (202) is operatively coupled to the powerhead compressor (140) via the engine shaft (120).

A17. The gas turbine engine starter system (100) of any of paragraphs A10-A16, wherein the gas turbine engine (110) further includes an air intake (130) for introducing the engine airflow (132) into the powerhead compressor (140).

A18. The gas turbine engine starter system (100) of any of paragraphs A10-A17, wherein the gas turbine engine (110) further includes an exhaust outlet (180) for exhausting the combustion gases (136) from the gas turbine engine (110).

A19. The gas turbine engine starter system (100) of any of paragraphs A1-A18, further comprising a gearbox (102) that operatively interconnects the starter torque output (202) and the gas turbine engine (110).

A20. The gas turbine engine starter system (100) of paragraph A19, wherein the gearbox (102) is operatively coupled to the engine shaft (120).

A21. The gas turbine engine starter system (100) of any of paragraphs A1-A20, wherein the starter torque output (202) includes one or more of a gear, a pinion gear, and a splined mechanical interface.

A22. The gas turbine engine starter system (100) of any of paragraphs A1-A21, wherein the engine starter (200) includes a starter motor (210) configured to produce the starter torque.

A23. The gas turbine engine starter system (100) of paragraph A22, wherein the engine starter (200) includes a one-way clutch mechanism (220); and wherein the starter motor (210) is operatively coupled to the starter torque output (202) via the one-way clutch mechanism (220) to prevent the gas turbine engine (110) from driving the starter motor (210).

A24. The gas turbine engine starter system (100) of paragraph A22, wherein the starter motor (210) includes a starter generator (230) configured to receive a torque from the starter torque output (202) and to generate an electrical current during operation of the gas turbine engine (110).

A25. The gas turbine engine starter system (100) of any of paragraphs A1-A24, further comprising a starter power supply (104) configured to provide electrical power to the engine starter (200) to produce the starter torque.

A26. The gas turbine engine starter system (100) of paragraph A25, wherein the starter power supply (104) is spatially removed from each of the engine starter (200) and the gas turbine engine (110).

A27. The gas turbine engine starter system (100) of any of paragraphs A1-A26, further comprising an engine controller (190) programmed to generate and transmit a starter control signal (192) to at least partially control operation of the engine starter (200).

A28. The gas turbine engine starter system (100) of paragraph A27, wherein the engine controller (190) is programmed to generate the starter control signal (192) such that the engine rotational speed follows a/the selected predetermined engine target acceleration profile (306) during at least a portion of the spool-up time interval (350).

A29. The gas turbine engine starter system (100) of any of paragraphs A27-A28, wherein the engine controller (190) is programmed to generate the starter control signal (192) such that the speed-dependent regulated torque value (312) of the starter torque is less than the speed-dependent maximum torque value (302) of the starter torque at each starter rotational speed of an interval of starter rotational speeds that are produced during at least a portion of the spool-up time interval (350).

A30. The gas turbine engine starter system (100) of any of paragraphs A27-A29, wherein the starter control signal (192) includes, and optionally is, an electrical power signal (194) that powers the engine starter (200).

A31. The gas turbine engine starter system (100) of paragraph A30, wherein the engine controller (190) is programmed to modulate one or both of an electrical current and an electrical voltage of the electrical power signal (194) to regulate operation of the engine starter (200).

A32. The gas turbine engine starter system (100) of any of paragraphs A27-A31, wherein the engine controller (190) is programmed to transmit the starter control signal (192) to the engine starter (200).

A33. The gas turbine engine starter system (100) of paragraph A32, wherein the engine controller (190) is programmed to transmit the starter control signal (192) directly to a/the starter motor (210).

A34. The gas turbine engine starter system (100) of any of paragraphs A27-A33, further comprising a starter controller (240) configured to at least partially control operation of a/the starter motor (210); and wherein the engine controller (190) is programmed to transmit the starter control signal (192) to the starter controller (240).

A35. The gas turbine engine starter system (100) of paragraph A34, wherein the engine starter (200) includes the starter controller (240).

A36. The gas turbine engine starter system (100) of any of paragraphs A34-A35, wherein the starter controller (240) is configured to transmit an/the electrical power signal (194) to the starter motor (210) to power the engine starter (200).

A37. The gas turbine engine starter system (100) of any of paragraphs A34-A36, wherein the starter controller (240) is configured to vary one or both of an/the electrical current and an/the electrical voltage of the electrical power signal (194) to regulate operation of the engine starter (200).

A38. The gas turbine engine starter system (100) of any of paragraphs A34-A37, wherein the starter controller (240) is configured to generate a starter status signal (242) that represents an operating condition of the engine starter (200) and to transmit the starter status signal (242) to the engine controller (190); and wherein the starter control signal (192) is based, at least in part, on the starter status signal (242).

A39. The gas turbine engine starter system (100) of paragraph A38, wherein the starter status signal (242) represents one or more of:

(i) the starter rotational speed;

(ii) a temperature of the engine starter (200);

(iii) a/the maximum starter torque curve (300); and

(iv) an actual value of the starter torque produced by the engine starter (200).

A40. The gas turbine engine starter system (100) of any of paragraphs A27-A39, wherein the engine controller (190) is programmed to receive a gas turbine engine status signal (112) that represents an operating condition of the gas turbine engine (110); and wherein the starter control signal (192) is based, at least in part, on the gas turbine engine status signal (112).

A41. The gas turbine engine starter system (100) of paragraph A40, wherein the gas turbine engine status signal (112) includes an engine speed signal (124) that represents the engine rotational speed.

A42. The gas turbine engine starter system (100) of paragraph A41, wherein the gas turbine engine (110) further includes an engine speed sensor (122) that is configured to measure the engine rotational speed and to generate the engine speed signal (124).

A43. The gas turbine engine starter system (100) of paragraph A42, wherein the engine speed sensor (122) is operatively coupled to the engine shaft (120).

A44. The gas turbine engine starter system (100) of any of paragraphs A40-A43, wherein the gas turbine engine status signal (112) represents a temperature associated with the gas turbine engine (110).

A45. The gas turbine engine starter system (100) of paragraph A44, wherein the gas turbine engine status signal (112) includes an exhaust gas temperature (EGT) signal (184) that represents an exhaust gas temperature (EGT) of a/the combustion gases (136) as the combustion gases (136) are exhausted from the gas turbine engine (110).

A46. The gas turbine engine starter system (100) of paragraph A45, wherein the gas turbine engine status signal (112) includes the EGT signal (184).

A47. The gas turbine engine starter system (100) of any of paragraphs A45-A46, further comprising an EGT sensor (182) configured to measure the EGT of the combustion gases (136) as the combustion gases (136) are exhausted from the gas turbine engine (110); and wherein the EGT sensor (182) is configured to generate and transmit the EGT signal (184).

A48. The gas turbine engine starter system (100) of paragraph A47, wherein the EGT sensor (182) is positioned downstream of a/the powerhead turbine (160).

A49. The gas turbine engine starter system (100) of any of paragraphs A47-A48, wherein the EGT sensor (182) is positioned within an/the exhaust outlet (180).

A50. The gas turbine engine starter system (100) of any of paragraphs A44-A49, wherein the gas turbine engine status signal (112) includes an oil temperature signal (188) that represents a temperature of an oil utilized by the gas turbine engine (110).

A51. The gas turbine engine starter system (100) of paragraph A50, further comprising an oil temperature sensor (186) that is configured to generate and transmit the oil temperature signal (188).

A52. The gas turbine engine starter system (100) of paragraph A51, wherein the oil temperature sensor (186) is operatively coupled to a/the gearbox (102).

A53. The gas turbine engine starter system (100) of any of paragraphs A27-A52, wherein the gas turbine engine starter system (100) is incorporated into a vehicle (10) that includes one or more vehicle status sensors (22); wherein each vehicle status sensor (22) of the one or more vehicle status sensors (22) is configured to generate and transmit a respective portion of a vehicle status signal (24) that represents an operational condition of the vehicle (10); and wherein the starter control signal (192) is based, at least in part, on the vehicle status signal (24).

A54. The gas turbine engine starter system (100) of paragraph A53, wherein the vehicle status signal (24) represents one or more of:

(i) an ambient temperature of air surrounding the vehicle (10);

(ii) an ambient pressure of air surrounding the vehicle (10);

(iii) a speed at which the vehicle (10) is traveling; and

(iv) an altitude at which the vehicle (10) is traveling.

A55. The gas turbine engine starter system (100) of any of paragraphs A27-A54, wherein the engine controller (190) is programmed to repeatedly update the starter control signal (192) during the spool-up time interval (350), optionally such that the engine rotational speed follows a/the selected predetermined engine target acceleration profile (306) during at least a portion of the spool-up time interval (350).

A56. The gas turbine engine starter system (100) of any of paragraphs A27-A55, wherein the engine controller (190) is programmed to determine a/the selected predetermined engine target acceleration profile (306); and optionally wherein the engine controller (190) programmed to determine the selected predetermined engine target acceleration profile (306) based, at least in part, on one or more of a/the starter status signal (242), a/the gas turbine engine status signal (112), a/the oil temperature signal (188), and a/the vehicle status signal (24).

A57. The gas turbine engine starter system (100) of any of paragraphs A1-A56, wherein the engine startup process further includes a dwell time interval (360) that initiates immediately subsequent to the end of the spool-up time interval (350); and wherein the gas turbine engine starter system (100) is configured such that the engine rotational speed remains within the engine starting speed envelope (330) during the dwell time interval (360).

A58. The gas turbine engine starter system (100) of paragraph A57, wherein an/the engine controller (190) is programmed to generate a/the starter control signal (192) such that the engine rotational speed remains within the engine starting speed envelope (330) during the dwell time interval (360).

A59. The gas turbine engine starter system (100) of any of paragraphs A57-A58, wherein the gas turbine engine starter system (100) is configured such that a/the speed-dependent regulated torque value (312) of the starter torque is less than the speed-dependent maximum torque value (302) of the starter torque at each starter rotational speed of an interval of starter rotational speeds that are produced during at least a portion of the dwell time interval (360).

A60. The gas turbine engine starter system (100) of paragraph A59, wherein an/the engine controller (190) is programmed to generate an/the starter control signal (192) such that the speed-dependent regulated torque value (312) of the starter torque is less than the speed-dependent maximum torque value (302) of the starter torque at each starter rotational speed of an interval of starter rotational speeds that are produced during at least a portion of the dwell time interval (360).

A61. The gas turbine engine starter system (100) of any of paragraphs A57-A60, wherein an/the engine controller (190) is programmed to repeatedly update the starter control signal (192) during the dwell time interval (360), optionally such that the engine rotational speed remains within the engine starting speed envelope (330) during the dwell time interval (360).

A62. The gas turbine engine starter system (100) of any of paragraphs A1-A61, wherein the engine startup process further includes a maximum torque interval (370) that initiates immediately subsequent to the end of a/the dwell time interval (360); and wherein the gas turbine engine starter system (100) is configured such that, during operative use of the gas turbine engine starter system (100) during the maximum torque interval (370), the starter torque is equal to the speed-dependent maximum torque value (302).

A63. The gas turbine engine starter system (100) of paragraph A62, wherein a/the engine controller (190) is programmed to generate the starter control signal (192) such that a/the speed-dependent regulated torque value (312) of the starter torque is equal to the speed-dependent maximum torque value (302) of the starter torque during at least a portion of the maximum torque interval (370).

A64. The gas turbine engine starter system (100) of any of paragraphs A62-A63, wherein an/the engine controller (190) is programmed to generate a/the starter control signal (192) such that the maximum torque interval (370) terminates when the engine rotational speed reaches a threshold cutoff speed (342) that is a threshold percentage of a steady-state operational engine rotational speed (340); and wherein the threshold percentage is one or more of at least 30%, at least 40%, at least 50%, at least 60%, at most 70%, at most 55%, at most 45%, and at most 35%.

A65. The gas turbine engine starter system (100) of any of paragraphs A1-A64, wherein the gas turbine engine (110) is a component of an auxiliary power unit (APU) (30).

A66. The gas turbine engine starter system (100) of paragraph A65, wherein the APU (30) includes a load compressor (32) that is configured to compress a load compressor airflow (34) to generate a bleed air flow (36); and wherein the gas turbine engine (110) is configured such that the engine torque drives the load compressor (32).

A67. The gas turbine engine starter system (100) of paragraph A66, wherein the engine shaft (120) operatively couples the powerhead turbine (160) to the load compressor (32) to convey the engine torque from the powerhead turbine (160) to the load compressor (32).

A68. The gas turbine engine starter system (100) of any of paragraphs A1-A67, wherein the gas turbine engine (110) is a component of a turbofan engine (40).

A69. The gas turbine engine starter system (100) of paragraph A68, wherein the turbofan engine (40) includes a fan (42) that is configured to accelerate an airflow to produce a thrust; and wherein the gas turbine engine (110) is configured such that the engine torque drives rotation of the fan (42).

A70. The gas turbine engine starter system (100) of paragraph A69, wherein the engine shaft (120) operatively couples the powerhead turbine (160) to the fan (42) to convey the engine torque from the powerhead turbine (160) to the fan (42).

B1. A vehicle (10) comprising the gas turbine engine starter system (100) of any of paragraphs A1-A70.

B2. The vehicle (10) of paragraph B1, wherein the vehicle (10) is an aircraft (20).

B3. The vehicle (10) of paragraph B2, wherein the aircraft (20) includes a/the turbofan engine (40); and wherein the turbofan engine (40) includes the gas turbine engine (110).

B4. The vehicle (10) of any of paragraphs B2-B3, wherein the aircraft (20) includes an/the APU (30); and wherein the APU (30) includes the gas turbine engine (110).

C1. A method (400) of operating a gas turbine engine starter system (100) to initiate operation of a gas turbine engine (110) during an engine startup process, wherein the gas turbine engine starter system (100) includes an engine starter (200) configured to generate a starter torque during the engine startup process to initiate operation of the gas turbine engine (110), and an engine controller (190) programmed to generate and transmit a starter control signal (192) to the engine starter (200), the method (400) comprising:

regulating (410), with the engine controller (190), the operation of the engine starter (200);

wherein the regulating (410) the operation of the engine starter (200) includes accelerating (418) the gas turbine engine (110) to bring an engine rotational speed of the gas turbine engine (110) to within an engine starting speed envelope (330) that encompasses a range of engine starting rotational speeds (332) corresponding to initiation of a combustion process within the gas turbine engine (110) during the engine startup process; and

wherein the accelerating (418) the gas turbine engine (110) includes operating the engine starter (200) such that the starter torque is less than a speed-dependent maximum torque value (302) of the starter torque that the engine starter (200) is configured to produce during at least a portion of a spool-up time interval (350) of the engine startup process in which the engine rotational speed increases from a non-operative engine rotational speed to a speed within the engine starting speed envelope (330).

C2. The method (400) of paragraph C1, wherein the method (400) is performed entirely within the engine startup process.

C3. The method (400) of any of paragraphs C1-C2, wherein the engine starter (200) is configured to produce a speed-dependent regulated torque value (312) of the starter torque during operative use of the gas turbine engine starter system (100); and wherein the regulating (410) the operation of the engine starter (200) includes regulating such that the speed-dependent regulated torque value (312) of the starter torque is less than the speed-dependent maximum torque value (302) of the starter torque at each starter rotational speed of an interval of starter rotational speeds that are produced during at least a portion of the spool-up time interval (350).

C4. The method (400) of any of paragraphs C1-C3, wherein the regulating (410) the operation of the engine starter (200) includes:

generating (412), with the engine controller (190), the starter control signal (192); and

transmitting (416), with the engine controller (190), the starter control signal (192) to the engine starter (200).

C5. The method (400) of paragraph C4, wherein the generating (412) the starter control signal (192) includes generating (414) an electrical power signal (194) that powers the engine starter (200).

C6. The method (400) of paragraph C5, wherein the generating (412) the starter control signal (192) includes modulating one or both of an electrical current and an electrical voltage of the electrical power signal (194).

C7. The method (400) of any of paragraphs C4-C6, wherein the engine starter (200) includes a starter motor (210) configured to produce the starter torque; and wherein the transmitting (416) the starter control signal (192) to the engine starter (200) includes transmitting the starter control signal (192) directly to the starter motor (210).

C8. The method (400) of paragraph C7, wherein the transmitting (416) the starter control signal (192) to the engine starter (200) includes transmitting the electrical power signal (194) to the starter motor (210).

C9. The method (400) of any of paragraphs C4-C8, wherein the engine starter (200) includes a/the starter motor (210) configured to produce the starter torque; wherein the gas turbine engine starter system (100) further includes a starter controller (240) configured to at least partially control operation of the starter motor (210); and wherein the transmitting (416) the starter control signal (192) includes transmitting the starter control signal (192) to the starter controller (240).

C10. The method (400) of any of paragraphs C4-C9, wherein the generating (412) the starter control signal (192) includes generating such that the engine rotational speed follows a selected predetermined engine target acceleration profile (306) during at least a portion of the spool-up time interval (350).

C11. The method (400) of any of paragraphs C4-C10, wherein the generating (412) the starter control signal (192) includes repeatedly updating the starter control signal (192) during the spool-up time interval (350) such that the engine rotational speed follows a/the selected predetermined engine target acceleration profile (306) during at least a portion of the spool-up time interval (350).

C12. The method (400) of any of paragraphs C1-C11, further comprising, prior to the regulating (410) the operation of the engine starter (200), determining (408), with the engine controller (190), a/the selected predetermined engine target acceleration profile (306).

C13. The method (400) of any of paragraphs C1-C12, further comprising:

receiving (402), with the engine controller (190), a starter status signal (242) that represents an operating condition of the engine starter (200); and

wherein the regulating (410) the operation of the engine starter (200) is based, at least in part, on the starter status signal (242).

C14. The method (400) of paragraph C13, wherein the generating (412) the starter control signal (192) is based, at least in part, on the starter status signal (242).

C15. The method (400) of any of paragraphs C13-C14, wherein a/the determining (408) the selected predetermined engine target acceleration profile (306) is based, at least in part, on the starter status signal (242).

C16. The method (400) of any of paragraphs C1-C15, further comprising:

receiving (404), with the engine controller (190), a gas turbine engine status signal (112) that represents an operating condition of the gas turbine engine (110); and

wherein the regulating (410) the operation of the engine starter (200) is based, at least in part, on the gas turbine engine status signal (112).

C17. The method (400) of paragraph C16, wherein the generating (412) the starter control signal (192) is based, at least in part, on the gas turbine engine status signal (112).

C18. The method (400) of any of paragraphs C16-C17, wherein a/the determining (408) the selected determined engine target acceleration profile (306) is based, at least in part, on the gas turbine engine status signal (112).

C19. The method (400) of any of paragraphs C1-C18, wherein the gas turbine engine starter system (100) is incorporated into a vehicle (10) that includes one or more vehicle status sensors (22), wherein each vehicle status sensor (22) of the one or more vehicle status sensors (22) is configured to generate and transmit a respective portion of a vehicle status signal (24) that represents an operational condition of the vehicle (10);

wherein the method (400) further comprises:

receiving (406), with the engine controller (190), the vehicle status signal (24); and

wherein the regulating (410) the operation of the engine starter (200) is based, at least in part, on the vehicle status signal (24).

C20. The method (400) of paragraph C19, wherein the generating (412) the starter control signal (192) is based, at least in part, on the vehicle status signal (24).

C21. The method (400) of any of paragraphs C19-C20, wherein a/the determining (408) the selected predetermined engine target acceleration profile (306) is based, at least in part, on the vehicle status signal (24).

C22. The method (400) of any of paragraphs C1-C21, wherein the regulating (410) the operation of the engine starter (200) further includes maintaining (420) the engine rotational speed within the engine starting speed envelope (330) during a dwell time interval (360) of the engine startup process that initiates immediately subsequent to the end of the spool-up time interval (350).

C23. The method (400) of paragraph C22, wherein the regulating (410) the operation of the engine starter (200) includes generating the starter control signal (192) such that a/the speed-dependent regulated torque value (312) the starter torque is less than a/the speed-dependent maximum torque value (302) of the starter torque at each starter rotational speed of an interval of starter rotational speeds that are produced during at least a portion of the dwell time interval (360).

C24. The method (400) of any of paragraphs C22-C23, wherein the generating (412) the starter control signal (192) includes repeatedly updating the starter control signal (192) during the dwell time interval (360) such that the engine rotational speed remains within the engine starting speed envelope (330) during the dwell time interval (360).

C25. The method (400) of any of paragraphs C1-C24, wherein the regulating (410) the operation of the engine starter (200) further includes, subsequent to the maintaining (420) the engine rotational speed within the engine starting speed envelope (330), generating (422), with the engine starter (200), a maximum starter torque during a maximum torque interval (370) of the engine startup process that initiates immediately subsequent to the end of a/the dwell time interval (360).

C26. The method (400) of paragraph C25, wherein the generating (422) the maximum starter torque includes a/the generating (412) the starter control signal (192) such that a/the speed-dependent regulated torque value (312) of the starter torque is equal to the speed-dependent maximum torque value (302) of the starter torque during the maximum torque interval (370).

C27. The method (400) of any of paragraphs C25-C26, wherein the generating (422) the maximum starter torque is performed responsive to an indication that the gas turbine engine (110) has initiated operation, optionally an indication that stable combustion has initiated within the gas turbine engine (110).

C28. The method (400) of any of paragraphs C25-C27, wherein a/the receiving (404) the gas turbine engine status signal (112) includes receiving an exhaust gas temperature (EGT) signal (184) that indicates an EGT of combustion gases (136) generated by the gas turbine engine (110); and wherein the generating (422) the maximum starter torque is performed responsive to the EGT signal (184) indicating that the EGT exceeds a threshold EGT.

C29. The method (400) of any of paragraphs C1-C28, wherein the regulating (410) the operation of the engine starter (200) further includes ceasing (424) operation of the engine starter (200).

C30. The method (400) of paragraph C29, wherein the ceasing (424) the operation of the engine starter (200) includes ceasing to transmit the starter control signal (192) to the engine starter (200).

C31. The method (400) of any of paragraphs C29-C30, wherein the ceasing (424) the operation of the engine starter (200) is performed at the end of a/the maximum torque interval (370).

C32. The method (400) of any of paragraphs C29-C31, wherein the ceasing (424) the operation of the engine starter (200) is performed responsive to a/the gas turbine engine status signal (112) indicating that the engine rotational speed has reached a threshold cutoff speed (342) that is a threshold percentage of a steady-state operational engine rotational speed (340); and wherein the threshold percentage is one or more of at least 30%, at least 40%, at least 50%, at least 60%, at most 70%, at most 55%, at most 45%, and at most 35%.

C33. The method (400) of any of paragraphs C1-C32, wherein the gas turbine engine starter system (100) is the gas turbine engine starter system (100) of any of paragraphs A1-A70.

As used herein, the phrase “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, a first direction that is at least substantially parallel to a second direction includes a first direction that is within an angular deviation of 22.5° relative to the second direction and also includes a first direction that is identical to the second direction.

As used herein, the phrase “nominally fully,” when modifying a degree or relationship, includes the full extent of the recited degree or relationship as well as degrees or relationships that differ from the full extent of the recited degree or relationship by up to 1%. For example, a first direction that is nominally fully parallel to a second direction includes a first direction that is within an angular deviation of 0.9° relative to the second direction and also includes a first direction that is identical to the second direction. In this manner, the phrase “nominally fully” may be substituted in place of the phrase “at least substantially.” Stated differently, as used herein, the phrase “at least substantially” is intended to encompass degrees or relationships that are described with the phrase “nominally fully.” Similarly, as used herein, the phrase “nominally equal,” as used to compare a first quantity and a second quantity, describes examples in which the first quantity and the second quantity are exactly equal to one another, as well as examples in which the first quantity and the second quantity differ from one another by up to 1%.

As used herein, the terms “selective” and “selectively,” when modifying an action, movement, configuration, or other activity of one or more components or characteristics of an apparatus, mean that the specific action, movement, configuration, or other activity is a direct or indirect result of one or more dynamic processes, as described herein. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order, concurrently, and/or repeatedly. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

The various disclosed elements of apparatuses and systems and steps of methods disclosed herein are not required to all apparatuses, systems, and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus, system, or method. Accordingly, such inventive subject matter is not required to be associated with the specific apparatuses, systems, and methods that are expressly disclosed herein and such inventive subject matter may find utility in apparatuses, systems, and/or methods that are not expressly disclosed herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A gas turbine engine starter system for initiating operation, during an engine startup process, of a gas turbine engine that includes an engine shaft that is configured to rotate at an engine rotational speed, the gas turbine engine starter system comprising:
an engine starter configured to generate a starter torque during the engine startup process to initiate operation of the gas turbine engine to produce an engine torque; and
a power supply configured to supply power to at least the engine starter;
wherein the engine starter includes a starter torque output that is configured to rotate at a starter rotational speed and to convey the starter torque to the gas turbine engine during the engine startup process to initiate operation of the gas turbine engine;
wherein the gas turbine engine is characterized by an engine starting speed envelope that encompasses a range of engine starting rotational speeds corresponding to initiation of a combustion process within the gas turbine engine during the engine startup process; wherein the engine startup process includes a spool-up time interval in which the engine rotational speed increases from a non-operative engine rotational speed to a speed within the engine starting speed envelope; wherein the gas turbine engine starter system is configured to operate the engine starter to produce, during operative use of the gas turbine engine starter system and during the spool-up time interval, the starter torque at less than a speed-dependent maximum torque value of the starter torque that the engine starter is configured to produce; and wherein the gas turbine engine starter system is configured to regulate a peak power requirement of the engine starter to permit the gas turbine engine to be initiated for operation with a decreased peak power draw from the power supply.

2. The gas turbine engine starter system of claim 1, wherein the engine starter is configured to produce a speed-dependent regulated torque value of the starter torque during operative use of the gas turbine engine starter system; and wherein the gas turbine engine starter system is configured such that, during operative use of the gas turbine engine starter system, the speed-dependent regulated torque value of the starter torque is less than the speed-dependent maximum torque value of the starter torque at each starter rotational speed of an interval of starter rotational speeds that are produced during the spool-up time interval.

3. The gas turbine engine starter system of claim 1, further comprising an engine controller programmed to generate and transmit a starter control signal to the engine starter; wherein the engine controller is programmed to generate the starter control signal such that the engine rotational speed follows a selected predetermined engine target acceleration profile during the spool-up time interval.

4. The gas turbine engine starter system of claim 3, wherein the engine starter includes a starter motor configured to produce the starter torque; wherein the gas turbine engine starter system further comprises a starter controller configured to control operation of the starter motor; and wherein the engine controller is programmed to transmit the starter control signal to the starter controller.

5. The gas turbine engine starter system of claim 3, wherein the engine controller is programmed to repeatedly update the starter control signal during the spool-up time interval such that the engine rotational speed follows the selected predetermined engine target acceleration profile during the spool-up time interval.

6. The gas turbine engine starter system of claim 1, wherein the engine startup process further includes a dwell time interval that initiates immediately subsequent to the end of the spool-up time interval; and wherein the gas turbine engine starter system is configured such that the engine rotational speed remains within the engine starting speed envelope during the dwell time interval.

7. The gas turbine engine starter system of claim 1, wherein the engine starter is configured to produce a speed-dependent regulated torque value of the starter torque during operative use of the gas turbine engine starter system; and wherein the gas turbine engine starter system is configured such that the speed-dependent regulated torque value of the starter torque is less than the speed-dependent maximum torque value of the starter torque at each starter rotational speed of an interval of starter rotational speeds that are produced during at least a portion of a dwell time interval that initiates immediately subsequent to the end of the spool-up time interval.

8. A vehicle comprising the gas turbine engine starter system of claim 1.

9. The vehicle of claim 8, wherein the vehicle is an aircraft; and wherein one or both of:
(i) the aircraft includes a turbofan engine that includes the gas turbine engine; and
(ii) the aircraft includes an auxiliary power unit (APU) that includes the gas turbine engine.

10. A method of operating a gas turbine engine starter system to initiate operation of a gas turbine engine during an engine startup process, wherein the gas turbine engine starter system includes an engine starter configured to generate a starter torque during the engine startup process to initiate operation of the gas turbine engine and an engine controller programmed to generate and transmit a starter control signal to the engine starter, the method comprising:
regulating, with the engine controller, the operation of the engine starter;
wherein the regulating the operation of the engine starter includes accelerating the gas turbine engine to bring an engine rotational speed of the gas turbine engine to within an engine starting speed envelope that encompasses a range of engine starting rotational speeds corresponding to initiation of a combustion process within the gas turbine engine during the engine startup process;
wherein the accelerating the gas turbine engine includes operating the engine starter such that the starter torque is less than a speed-dependent maximum torque value of the starter torque that the engine starter is configured to produce during a spool-up time interval of the engine startup process in which the engine rotational speed increases from a non-operative engine rotational speed to a speed within the engine starting speed envelope; and
wherein during the spool-up time interval, the operating the engine starter permits the engine starter to initiate operation of the gas turbine engine with a decreased peak power draw from a power supply configured to provide power to at least the engine starter.

11. The method of claim 10, wherein the engine starter is configured to produce a speed-dependent regulated torque value of the starter torque during operative use of the gas turbine engine starter system; and wherein the regulating the operation of the engine starter includes regulating such that the speed-dependent regulated torque value of the starter torque is less than the speed-dependent maximum torque value of the starter torque at each starter rotational speed of an interval of starter rotational speeds that are produced during the spool-up time interval.

12. The method of claim 10, wherein the regulating the operation of the engine starter includes:
generating, with the engine controller, the starter control signal; and
transmitting, with the engine controller, the starter control signal to the engine starter.

13. The method of claim 12, wherein the generating the starter control signal includes generating such that the engine rotational speed follows a selected predetermined engine target acceleration profile during the spool-up time interval.

14. The method of claim 12, wherein the generating the starter control signal includes repeatedly updating the starter control signal during the spool-up time interval such that the engine rotational speed follows a selected predetermined engine target acceleration profile during the spool-up time interval.

15. The method of claim 12, further comprising:
receiving, with the engine controller, a gas turbine engine status signal that represents an operating condition of the gas turbine engine;
wherein each of the regulating the operation of the engine starter and the generating the starter control signal is based, at least in part, on the gas turbine engine status signal.

16. The method of claim 10, further comprising, prior to the regulating the operation of the engine starter, determining, with the engine controller, a selected predetermined engine target acceleration profile.

17. The method of claim 16, wherein the gas turbine engine starter system is incorporated into a vehicle that includes one or more vehicle status sensors, wherein each vehicle status sensor of the one or more vehicle status sensors is configured to generate and transmit a respective portion of a vehicle status signal that represents an operational condition of the vehicle;
wherein the method further comprises:
receiving, with the engine controller, the vehicle status signal;
wherein the regulating the operation of the engine starter is based, at least in part, on the vehicle status signal; and wherein the determining the selected predetermined engine target acceleration profile is based, at least in part, on the vehicle status signal.

18. The method of claim 10, wherein the regulating the operation of the engine starter further includes maintaining the engine rotational speed within the engine starting speed envelope during a dwell time interval of the engine startup process that initiates immediately subsequent to the end of the spool-up time interval.

19. The method of claim 10, wherein the engine starter is configured to produce a speed-dependent regulated torque value of the starter torque during operative use of the gas turbine engine starter system; and wherein the regulating the operation of the engine starter includes generating the starter control signal such that the speed-dependent regulated torque value of the starter torque is less than the speed-dependent maximum torque value of the starter torque at each starter rotational speed of an interval of starter rotational speeds that are produced during at least a portion of a dwell time interval that initiates immediately subsequent to the end of the spool-up time interval.

20. The method of claim 10, wherein the regulating the operation of the engine starter further includes generating, with the engine starter, a maximum starter torque during a maximum torque interval of the engine startup process that initiates immediately subsequent to the end of a dwell time interval that initiates immediately subsequent to the end of the spool-up time interval.
